(19) United States
(12) Patent Application Publication
(10) Pub. No.: US 2015/0225512 A1
(43) Pub. Date: Aug. 13, 2015

(54) POLYMER COMPOSITION

(71) Applicants: Taichi Nemoto, (US); Chiaki Tanaka, Shizuoka (JP)

(72) Inventors: Taichi Nemoto, Shizuoka (JP); Chiaki Tanaka, Shizuoka (JP)

(21) Appl. No.: 14/424,848

(22) PCT Filed: Sep. 12, 2013
(86) PCT No.: PCT/JP2013/075380

§ 371 Date: Feb. 27, 2015

(30) Foreign Application Priority Data
Sep. 14, 2012 (JP) 2012-202844

(51) Int. Cl. C08G 81/00

(52) U.S. Cl. CPC C08G 81/00

(57) ABSTRACT

To provide a polymer composition, which contains stereo complex crystals, and substantially no organic solvent, wherein an amount of ring-opening polymerizable monomer residues is 2 mol % or less.

### TECHNICAL FIELD

The present invention relates to a polymer composition containing stereo complex crystals.

### BACKGROUND ART

Conventionally, it has been known that a polymer composition having different characteristics to those of each polymer in thermal characteristics or mechanical characteristics can be obtained by mixing a plurality of polymers. For example, it has been know that by mixing poly-L-lactic acid and poly-D-lactic acid, stereo complex crystals are formed, and a polymer composition having the higher melting point and improved mechanical strength than each polymer can be generated.

As for a method for producing a polymer composition containing stereo complex crystals, disclosed is, for example, a method containing dissolving poly-L-lactic acid and poly-D-lactic acid in chloroform to mix the polymers in a solution state (see PTL 1). In the case where a polymer composition is produced by this method, however, it is necessary to provide a treatment for drying an organic solvent, such as chloroform, after the mixing. Moreover, even performing this treatment, it is difficult to completely remove the organic solvent from the polymer composition, and thus stability of the polymer composition may be impaired.

As for a method for producing a polymer composition containing stereo complex crystals without using an organic solvent, disclosed is, for example, a method containing heating and melting poly-L-lactic acid and poly-D-lactic acid at the temperature of 200° C., and mixing by means of an extruder (see PTL 2). In this literature, it is disclosed that the poly-L-lactic acid and poly-D-lactic acid can be processed at temperature around the melting points of these polymers, if each polymer is crystallized.

### CITATION LIST

### Patent Literature

PTL 1: Japanese Patent Publication Application (JP-B) No. 05-48258
PTL 2: Japanese Patent (JP-B) No. 3610780

### Non-Patent Literature

NPL 1: “The Latest Applied Technology of Supercritical Fluid (CHO RINKAI RYUTAI NO SAISHIN OUYOU GIJUTSU),” p. 173, published by NTS Inc. on Mar. 15, 2004

### SUMMARY OF INVENTION

### Technical Problem

In a polymer obtained through polymerization of a ring-opening polymerizable monomer, such as polylactic acid, however, an equilibrium relationship is satisfied between the polymer and the ring-opening polymerizable monomer. In the case where a plurality of polymers are heated to temperature higher than melting points thereof and mixed in order to form stereo complex crystals, therefore, a ring-opening polymerizable monomer is generated as a result of a depolymerization reaction. Accordingly, ring-opening polymerizable monomers are remained in the polymer composition obtained by mixing, which cases a problem that physical properties of the polymer composition are degraded.

### Solution to Problem

The polymer composition of the present invention contains:

stereo complex crystals; and

substantially no organic solvent,

wherein an amount of ring-opening polymerizable monomer residues is 2 mol % or less.

### Advantageous Effects of Invention

As explained above, the polymer composition of the present invention, which contains stereo complex crystals, contains substantially no organic solvent, and has a ring-opening polymerizable monomer residue amount of 2 mol % or less, which is smaller compared to a conventional polymer composition obtained by heating and mixing. Therefore, the polymer composition has an effect that the degradation of the physical properties thereof due to an influence of ring-opening polymerizable monomer residues can be prevented.

### BRIEF DESCRIPTION OF DRAWINGS

FIG. 1 is a general phase diagram depicting a state of a substance depending on temperature and pressure.

FIG. 2 is a phase diagram, which defines a rage of a compressive fluid used in the present embodiment.

FIG. 3 is a schematic diagram illustrating one example of a complex production device.

FIG. 4 is a schematic diagram illustrating one example of a polymerization reaction device.

FIG. 5 is a schematic diagram illustrating one example of a complex production device.

### DESCRIPTION OF EMBODIMENTS

One embodiment of the present invention will be specifically explained hereinafter. The polymer composition of the present embodiment contains a plurality of polymers obtained through ring-opening polymerization of ring-opening polymerizable monomers using a compressive fluid and a catalyst, and the polymer composition is obtained by mixing these polymers using the compressive fluid.

### <<Raw Materials>>

First, a component, such as monomers, used as raw materials in production of the polymer composition is explained. In the present embodiment, the raw materials are materials from which polymers are produced, and contain monomer and may further contain appropriately selected optional components, such as an initiator, and additives, if necessary.

### <Monomers>

As for monomers as the raw materials for use in the present embodiment, a first ring-opening polymerizable monomer (referred to as a “first monomer” hereinafter), and a second ring-opening polymerizable monomer (referred to as a “second monomer” hereinafter) are used. Note that, the “ring-opening polymerizable” means that a monomer can undergo ring-opening polymerization.

### (First Monomer)

The first monomer is preferably a monomer containing a carbonyl bond, such as an ester bond, in a ring thereof, although it depends on a combination with a compressive fluid for use. The carbonyl bond is formed by bonding oxygen, which has high electronegativity, and a carbon atom with a π-bond. Because of electrons of the π-bond, oxygen is negatively polarized, and carbon is positively polarized, and therefore reactivity is enhanced. In the case where the compressive fluid is carbon dioxide, it is assumed that affinity between carbon dioxide and a generated polymer is high, as the carbonyl skeleton is similar to the structure of carbon dioxide. As a result of these functions, a plasticizing effect of the generated polymer using the compressive fluid is enhanced. Examples of the first monomer having a carbonyl bond in a ring thereof include cyclic ester, and cyclic carbonate. Through ring-opening polymerization of the first monomer having a carbonyl bond in a ring thereof, a first polymer having a carbonyl bond, such as polyester and polycarbonate, is obtained. Note that, in the present embodiment, one of optical isomers (e.g., L-form) is used as the first monomer.

The cyclic ester is not particularly limited, but it is preferably a cyclic dimer obtained through dehydration-concentration of an L-form or D-form of a compound represented by the following general formula 1.

R—C*—H(—OH)(—COOH) General Formula 1

In the general formula 1, R is a C1-C10 alkyl group, and C* represents an asymmetric carbon.

Examples of the compound represented by the general formula 1 include enantiomers of lactic acid, enantiomers of 2-hydroxybutanoic acid, enantiomers of 2-hydroxypentanoic acid, enantiomers of 2-hydroxyhexanoic acid, enantiomers of 2-hydroxyheptanoic acid, enantiomers of 2-hydroxyoctanoic acid, enantiomers of 2-hydroxynonanoic acid, enantiomers of 2-hydroxydecanoic acid, enantiomers of 2-hydroxyundecanoic acid, and enantiomers of 2-hydroxydodecanoic acid. Among them, enantiomers of lactic acid are preferable since they are highly reactive and readily available. These cyclic dimers may be used independently or in combination.

The usable cyclic ester other than the cyclic dimer obtained through dehydration-concentration of the L-form or D-form of the compound represented by the following general formula 1 include, for example, aliphatic lactone, such as β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, glycolide and lactide. Among them, ε-caprolactone is preferable since it is highly reactive and readily available.

Moreover, the cyclic carbonate is not particularly limited, but examples thereof include ethylene carbonate, and propylene carbonate.

These first monomers may be used independently, or in combination.

### (Second Monomer)

The second monomer for use in the present invention is an optical isomer of the first monomer. In the case where the first monomer is L-lactide, for example, the second monomer is D-lactide. Since the first monomer and the second monomer are optical isomers to each other, a polymer composition containing stereo complex crystals is obtained by mixing the first polymer obtained through ring-opening polymerization of the first monomer and the second polymer obtained through ring-opening polymerization of the second monomer.

### (Other Monomers)

In the present embodiment, other monomers may be used in addition to the first monomer or the second monomer. In this case, a polymer is obtained as a multi-block copolymer containing a block composed of the first monomer or the second monomer, and a block composed of the aforementioned other monomers. Other monomers are particularly limited, but examples thereof include, other than the aforementioned ring-opening polymerizable monomers, an isocyanate compound, and a glycidyl compound. The isocyanate compound is not particularly limited, and examples thereof include a conventional polyfunctional isocyanate compound, such as isophorone diisocyanate, hexamethylene diisocyanate, lysin diisocyanate, xylene diisocyanate, tolylene diisocyanate, diphenyl methane diisocyanate, and cyclohexane diisocyanate. The glycidyl compound is not particularly limited, and examples thereof include a conventional polyfunctional glycidyl compound, such as diethylene glycol diglycidyl ether, polyethylene glycol diglycidyl ether, neopentyl glycol diglycidyl ether, 1,6-hexanediol diglycidyl ether, and diglycidyl terephthalate.

### <Catalyst>

In the present embodiment, a catalyst is preferably used. The catalyst for use in the present embodiment is appropriately selected depending on the intended purpose, and the catalyst may be a metal catalyst containing a metal atom, or an organic catalyst containing no metal atom.

The metal catalyst is not particularly limited, and examples thereof include conventional metal catalysts, such as a tin-based compound (e.g., tin octate, tin dibutyrate, and tin di(2-ethylhexanoate)), an aluminum-based compound (e.g., aluminum acetylacetonate, and aluminum acetate), a titanium-based compound (e.g., tetraisopropyl titanate, and tetrabutyl titanate), a zirconium-based compound (e.g., zirconium isopropoxide), and an antimony-based compound (e.g., antimony trioxide).

As for the catalyst for use in the present embodiment, the organic catalyst containing no metal atom is suitably used in the use required for safety and stability of the composition. Use of the organic catalyst containing no metal atom as the catalyst is preferable in the present invention, because the time required for a polymerization reaction is reduced, and a production method of a polymer having excellent polymerization rate can be provided, compared to a conventional production method where a ring-opening polymerizable monomer is allowed to go through ring-opening polymerization using an organic catalyst. In the present embodiment, the organic catalyst is any organic catalyst, provided that it contributes to a ring-opening reaction of the ring-opening polymerizable monomer to form an active intermediate together with the ring-opening polymerizable monomer, and it then can be removed and regenerated through a reaction with alcohol.

The organic catalyst is preferably a compound serving as a nucleophilic agent having basicity, more preferably a compound (a nitrogen compound) containing a nucleophilic nitrogen atom and having basicity, and even more preferably a cyclic compound containing a nucleophilic nitrogen atom and having basicity. Note that, the “nucleophilic agent (or nucleophilic)” is a chemical species (or characteristics thereof) that reacts with an electrophilie. The aforementioned compound is not particularly limited, and examples thereof include cyclic monoamine, cyclic diamine (a cyclic diamine compound having an amidine skeleton), a cyclic triamine compound having a guanidine skeleton, a heterocyclic aromatic organic compound containing a nitrogen atom, and N-heterocyclic carbene. A cationic organic catalyst can be used for the aforementioned ring-opening polymerization reaction, but the cationic organic catalyst pulls hydrogen atoms out of the polymer backbone (back-biting). As a result, a resulting polymer composition tends to have a wide molecular weight distribution, and it is difficult to obtain a polymer composition of a high molecular weight.

Examples of the cyclic monoamine include quinuclidine. Examples of the cyclic diamine include 1,4-diazabicyclo-[2.2.2]octane (DABCO), and 1,5-diazabicyclo(4,3,0)-5-nonene. Examples of the cyclic diamine compound having an amidine skeleton include 1,8-diazabicyclo[5.4.0]undec-7-ene (DBU), and diazabicyclononene. Examples of the cyclic triamine compound having a guanidine skeleton include 1,5,7-triazabicyclo[4.4.0]dec-5-ene (TBD), and diphenyl guanidine (DPG).

Examples of the heterocyclic aromatic organic compound containing a nitrogen atom include N,N-dimethyl-4-aminopyridine (DMAP), 4-pyrrolidinopyridine (PPY), pyrrocolin, imidazol, pyrimidine and purine. Examples of the N-heterocyclic carbine include 1,3-di-tert-butylimidazol-2-ylidene (ITBU).

Among them, DABCO, DBU, DPG, TBD, DMAP, PPY, and ITBU are preferable, as they have high nucleophilicity without being greatly affected by steric hindrance, or they have such boiling points that they can removed under the reduced pressure.

Among these organic catalysts, for example, DBU is liquid at room temperature, and has a boiling point. In the case where such organic catalyst is selected for use, the organic catalyst can be removed substantially quantitatively from the obtained polymer by treating the polymer under the reduced pressure. Note that, the type of the organic solvent, or whether or not a removal treatment is performed, is determined depending on an intended use of a polymer composition.

A type and an amount of the organic catalyst for use cannot be collectively determined as they vary depending on a combination of the compressive fluid, and ring-opening polymerizable monomers, but the amount thereof is preferably 0.01 mol % to 15 mol %, more preferably 0.1 mol % to 1 mol %, and even more preferably 0.3 mol % to 0.5 mol %, relative to 100 mol % of the ring-opening polymerizable monomers. When the amount thereof is smaller than 0.01 mol %, the organic catalyst is deactivated before completion of the polymerization reaction, and as a result a polymer having a target molecular weight cannot be obtained in some cases. When the amount thereof is greater than 15 mol %, it may be difficult to control the polymerization reaction.

### <Optional Components>

In the present embodiment, in addition to the aforementioned monomers, additives, such as a ring-opening polymerization initiator (initiator) and other additives, can be used as optional components of raw materials.

### (Initiator)

In the present embodiment, an initiator is preferably used for controlling a molecular weight of a polymer to be obtained. As for the initiator, a conventional initiator can be used. The initiator may be, for example, mono-, di-, or polyhydric alcohol, in cased of an alcohol-based initiator, and may be a saturated compound or unsaturated compound. Specific examples of the initiator include: monoalcohol, such as methanol, ethanol, propanol, butanol, pentanol, hexanol, heptanol, nonanol, decanol, lauryl alcohol, myristyl alcohol, cetyl alcohol, and stearyl alcohol; dialcohol, such as ethylene glycol, 1,2-propanediol, 1,3-propanediol, 1,3-butanediol, 1,4-butanediol, hexanediol, nonanediol, tetramethylene glycol, and polyethylene glycol; polyhydric alcohol such as glycerol, sorbitol, xylitol, ribitol, erythritol, and triethanol amine; and others such as methyl lactate, and ethyl lactate.

Moreover, a polymer having an alcohol residue at a terminal thereof, such as polycaprolactonediol, and polytetramethylene glycol, can be used as the initiator. Use of such polymer enables to synthesize diblock or triblock copolymers.

An amount of the initiator for use is appropriately adjusted depending on a target molecular weight of a resulting product, but it is preferably 0.05 mol % to 5 mol % relative to 100 mol % of the ring-opening polymerizable monomer. In order to prevent polymerization from being initiated unevenly, the initiator is ideally sufficiently mixed with the ring-opening polymerizable monomer before the ring-opening polymerizable monomer is brought into contact with a polymerization catalyst.

### (Additives)

Moreover, additives may be added for ring-opening polymerization, if necessary. Examples of the additives include a surfactant, an antioxidant, a stabilizer, an anticlouding agent, an UV-ray absorber, a pigment, a colorant, inorganic particles, various fillers, a thermal stabilizer, a flame retardant, a crystal nucleus agent, an antistatic agent, a surface wet improving agent, a combustion adjuvant, a lubricant, a natural product, a mold-releasing agent, a plasticizer, and other similar additives. If necessary, a polymerization terminator (e.g., benzoic acid, hydrochloric acid, phosphoric acid, metaphosphoric acid, acetic acid and lactic acid) may be used after completion of polymerization reaction. An amount of the additives may vary depending on the purpose for adding the additives, or types of the additives, but it is preferably 0 parts by mass to 5 parts by mass relative to 100 parts by mass of the polymer composition.

As for the stabilizer, for example, epoxidized soybean oil, or carbodiimide is used. As for the antioxidant, for example, 2,6-di-t-butyl-4-methyl phenol, or butylhydroxyanisol is used. As for the anticlouding agent, for example, glycerin fatty acid ester, or monostearyl citrate is used. As for fillers, for example, an UV-ray absorber, a thermal stabilizer, a flame retardant, an internal mold release agent, or inorganic additives having an effect of a crystal nucleus agent (e.g., clay, talc, and silica) is used. As for the pigment, for example, titanium oxide, carbon black, or ultramarine blue is used.

### <<Compressive Fluid>>

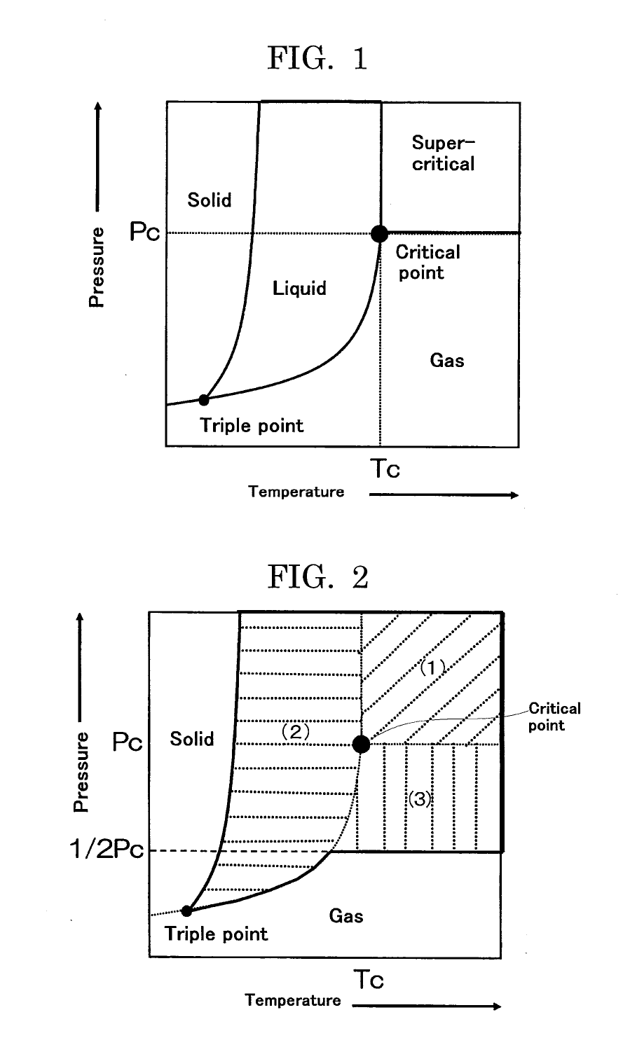

Next, a compressive fluid for use in the production of polymers in the present embodiment is explained with reference to FIGS. 1 and 2. FIG. 1 is a phase diagram depicting a state of a substance depending on temperature and pressure. FIG. 2 is a phase diagram defining a range of a compressive fluid in the present embodiment. In the present embodiment, the “compressive fluid” means a fluid in the state with which it is present in any one of the regions (1), (2) and (3) of FIG. 2 in the phase diagram of FIG. 1.

In such regions, the substance is known to have extremely high density and show different behaviors from those shown at normal temperature and normal pressure. Note that, a substance is a supercritical fluid when it is present in the region (1). The supercritical fluid is a fluid that exists as a fluid at temperature and pressure exceeding the corresponding limits (critical points), at which a gas and a liquid can coexist, and is a fluid, which is not condensed as being compressed. When a substance is in the region (2), the substance is a liquid, but in the present embodiment, it is a liquefied gas obtained by compressing a substance existing as a gas at normal temperature (25° C.) and normal pressure (1 atm). When a substance is in the region (3), the substance is in the state of a gas, but in the present embodiment, it is a high-pressure gas whose pressure is ½ or higher than the critical pressure (Pc), i.e. ½Pc or higher.

Examples of a substance that can be used in the state of the compressive fluid include carbon monoxide, carbon dioxide, dinitrogen oxide, nitrogen, methane, ethane, propane, 2,3-dimethylbutane, and ethylene. Among them, carbon dioxide is preferable because the critical pressure and critical temperature of carbon dioxide are respectively about 7.4 MPa, and about 31° C., and thus a supercritical state of carbon dioxide is easily formed. In addition, carbon dioxide is non-flammable, and therefore it is easily handled. These compressive fluids may be used independently, or in combination.

In the case where supercritical carbon dioxide is used as a solvent, it has been conventionally considered that carbon dioxide is not suitable for living anionic polymerization, as it may react with basic and nucleophilic substances (see “The Latest Applied Technology of Supercritical Fluid (CHO RINKAI RYUTAI NO SAISHIN OUYOU GIJUTSU),” p. 173, published by NTS Inc. on Mar. 15, 2004). However, the present inventors have found that, overturning the conventional insight, a polymerization reaction progresses quantitatively for a short period, by stably coordinating a basic and nucleophilic organic catalyst with a ring-opening monomer even in supercritical carbon dioxide, to thereby open the ring structure thereof, and as a result, the polymerization reaction progresses livingly. In the present specification, the term “living” means that the reaction progresses quantitatively without a side reaction such as a transfer reaction or termination reaction, so that a molecular weight distribution of an obtained polymer is relatively narrow compared to that of the polymer obtained by melt polymerization, and is monodispersible.

### <<Production Device>>

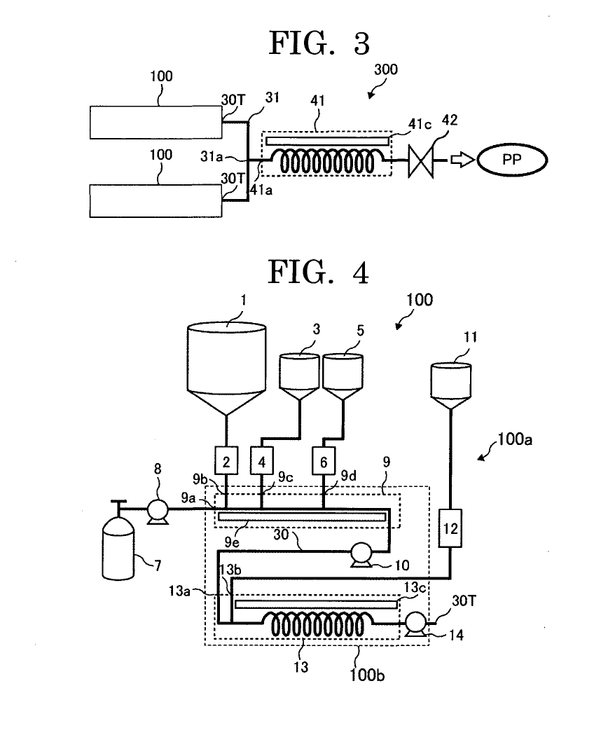

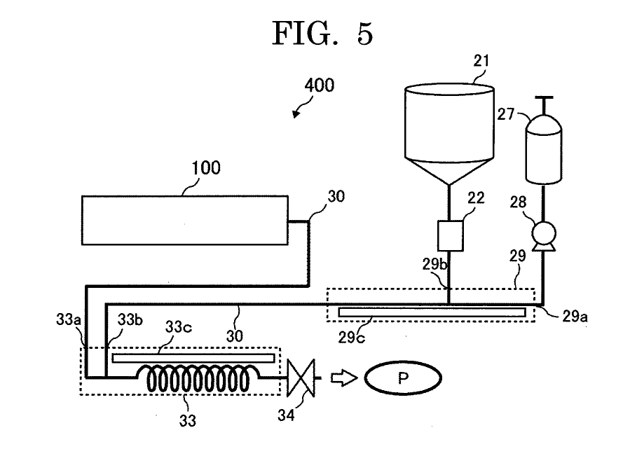

Subsequently, a production device suitably used for producing a polymer composition in the present embodiment will be explained with reference to FIGS. 3 to 5. FIG. 3 is a schematic diagram illustrating one example of a complex production device. FIG. 4 is a schematic diagram illustrating one example of a polymerization reaction device. FIG. 5 is a schematic diagram illustrating one example of a complex production device. The production of the polymer composition is performed with continuous processes in the present embodiment.

### <First Production Device>

First, a complex production device 300 as a first production device is explained with reference to FIGS. 3 and 4. The complex production device 300 contains a plurality of polymerization reaction devices 100 each configured to polymerize a monomer to obtain a polymer, pipeline 31 for transporting the obtained polymers, a blending device 41 configured to mix the transported polymers, and a pressure control valve 42 for discharging the obtained complex (polymer composition) by the mixing.

A polymerization reaction device 100, in which a plurality of complex production devices 300 are provided, is explained with reference to FIG. 4. Note that, the plurality of polymerization reaction devices 100 have the same structures, expect a difference that a monomer to be polymerized in each polymerization reaction device is a first monomer or second monomer. Each polymerization reaction device 100 contains a supply unit 100a configured to supply raw materials, such as a ring-opening polymerizable monomer, and a compressive fluid, and a polymerization reaction device main body 100b configured to polymerize the ring-opening polymerizable monomer supplied by the supply unit 100a.

The supply unit 100a contains tanks (1, 3, 5, 7, 11), metering feeders (2, 4), and metering pumps (6, 8, 12).

The tank 1 of the supply unit 100a stores therein a ring-opening polymerizable monomer as a first monomer or second monomer. The ring-opening polymerizable monomer to be stored may be a powder or liquid. The tank 3 stores solids (powder or particles) among the materials used as an initiator and additives. The tank 5 stores liquids among the materials used as the initiator and additives. Note that, it is also possible that part or the entire materials used as the initiator and additives are mixed with a ring-opening polymerizable monomer in advance, and the resulting mixture is stored in the tank 1. The tank 7 stores a compressive fluid. The tank 11 stores a catalyst. Note that, the tank 7 may store gas or a solid that is transformed into a compressive fluid upon application of heat or pressure during the process for supplying to the polymerization reaction device main body 100b, or within the polymerization reaction device main body 100b. In this case, the gas or solid stored in the tank 7 is transformed in the state of (1), (2), or (3) of FIG. 2 in the polymerization reaction device main body 100b upon application of heat or pressure.

The metering feeder 2 measures the ring-opening polymerizable monomer stored in the tank 1, and continuously supplies the measured ring-opening polymerizable monomer to the polymerization reaction device main body 100b. The metering feeder 4 measures the solids stored in the tank 3 and continuously supplies the measured solids to the polymerization reaction device main body 100b. The metering pump 6 measures the liquids stored in the tank 5, and continuously supplies the measured liquids to the polymerization reaction device main body 100b. The metering pump 8 continuously supplies the compressive fluid stored in the tank 7 to the polymerization reaction device main body 100b at constant pressure with a constant flow rate. The metering pump 12 measures the catalyst stored in the tank 11, and supplies the measured catalyst to the polymerization reaction device main body 100b. Note that, in the present embodiment, the phrase “continuously supply” is used as a concept in reverse to a supply per batch, and means to supply in a manner that a polymer as a product of ring-opening polymerization is continuously obtained. Specifically, each material may be intermittently supplied as long as a polymer is continuously obtained. In the case where the materials used as the initiator and additives are all solids, the supply unit 100a may not have the tank 5 and the metering pump 6. Similarly, in the case where the materials used as the initiator and additives are all liquids, the supply unit 100a may not have the tank 3 and the metering feeder 4.

In the present embodiment, the polymerization reaction device main body 100b contains a contact section 9 provided at one end thereof, a liquid feeding pump 10 configured to feed the raw materials passed through contact section 9, and a reaction section 13 and a metering pump 14, which are provided the other end. Each section or device of the polymerization reaction device main body 100b is connected with the other sections or devices with a pressure resistant pipeline 30, which is configured to transport raw materials, compressive fluid, or generated polymer, as illustrated in FIG. 4. Moreover, each section or device of the polymerization reaction device main body 100b has a tube member through which the aforementioned raw materials are passed through.

The contact section 9 of the polymerization reaction device main body 100b is composed of a pressure resistant device or tube, which is configured to continuously bring the raw materials, such as the ring-opening polymerizable monomer, initiator, and additives, continuously supplied from each tank (1, 3, 5), into contact with a compressive fluid continuously supplied from the tank 7. In the contact section 9, the raw materials are melted, or dissolved by bringing the raw materials into contact with a compressive fluid. In the present embodiment, the term “melt” means that raw materials or a generated polymer is plasticized or liquidized with swelling as a result of the contact between the raw materials or generated polymer, and the compressive fluid. Moreover, the term “dissolve” means that the raw materials are dissolved in the compressive fluid. In the case where the ring-opening polymerizable monomer is dissolved, a flow phase is formed. In the case where the ring-opening polymerizable monomer is melted, a melt phase is formed. It is preferred that one phase of either the melt phase or the flow phase be formed for uniformly carrying out a reaction. In order to carry out the reaction in the state that a ratio of the raw materials is high relative to the compressive fluid, moreover, the ring-opening polymerizable monomer is preferably melted. Note that, in the present embodiment, the raw materials, such as the ring-opening polymerizable monomer, can be continuously brought into contact with the compressive fluid in the contact section 9 at the constant ratio of concentration, by continuously supplying the raw materials and the compressive fluid. As a result, the raw materials can be efficiently melted or dissolved.

The contact section 9 may be equipped with a tank-shape stirring device, or a tube-shape stirring device, but it is preferably a tube-shape device from one end of which raw materials are fed, and from the other end of which a mixture, such as a melt phase, and a flow phase is taken out. As for such device, preferred are a single screw stirring device, a twin-screw stirring device where screws are engaged with each other, a biaxial mixer containing a plurality of stirring elements which are engaged or overlapped with each other, a kneader containing spiral stirring elements which are engaged with each other, and a static mixer. Among them, the two-axial or multi-axial stirrer stirring elements of which are engaged with each other is particularly preferable because there is generated a less amount of the depositions of the reaction product onto the stirrer or container, and it has self-cleaning properties. In the case where the contact section 9 is not equipped with a stirring device, the contact section 9 is composed of part of the pressure resistant pipeline 30. Note that, in the case where the contact section 9 is composed of part of the pipeline 30, a ring-opening polymerizable monomer supplied to the contact section 9 is preferably heated and liquidized in advance, in order to surely mix all of the materials in the contact section 9. Note that, symbol 30T denotes one outlet of the pipeline 30.

The contact section 9 has an inlet 9a configured to introduce a compressive fluid supplied from the tank 7 by the metering pump 8, an inlet 9b configured to introduce a ring-opening polymerizable monomer supplied from the tank 1 by the metering feeder 2, an inlet 9c configured to introduce a powder supplied from the tank 3 by the metering feeder 4, and an inlet 9d configured to introduce a liquid supplied from the tank 5 by the metering pump 6. In the present embodiment, each inlet (9a, 9b, 9c, 9d) is composed of a connector. The connector is not particularly limited, and selected from conventional connectors, such as reducers, couplings, Y, T, and outlets. Moreover, a heater 9e configured to heat the supplied raw materials or compressive fluid is provided in the contact section 9.

A feeding pump 10 is provided between the contact section 9 and the reaction section 13 of the polymerization reaction device main body 100b. The feeding pump 10 configured to feed the raw materials melted or dissolved in the contact section 9 to the reaction section 13.

The reaction section 13 of the polymerization reaction device main body 100b is composed of a pressure resistant device or pipe configured to mix the melted or dissolved raw materials fed by the feeding pump 10 with a catalyst supplied by the metering pump 12 to continuously react the ring-opening polymerizable monomer through ring-opening polymerization. As a result of the ring-opening polymerization of the ring-opening polymerizable monomer performed in the reaction section 13, a polymer is continuously obtained.

To the reaction section 13, a tank-shaped blending device or a tube-shaped blending device may be provided, but the tube-shaped device is more preferably as it gives less dead space. In the case where a blending device is provided in the reaction section 13, a polymerization reaction can be carried out more uniformly and quantitatively, as sedimentation of a polymer can be prevented because of a difference in concentration between the raw materials and the generated polymer. As for such device, preferred is a dual- or multi-axial stirrer having screws engaging with each other, stirring elements of 2-flights (rectangle), stirring elements of 3-flights (triangle), or circular or multi-leaf shape (clover shape) stirring wings, in view of self-cleaning. In the case where raw materials including the catalyst are sufficiently mixed in advance, a motionless mixer, which divides and compounds (recombines) the flows in multiple stages, can also be used as the stirring device. Examples of the motionless mixer include: multiflux batch mixers disclosed in Japanese examined patent application publication (JP-B) Nos. 47-15526, 47-15527, 47-15528, and 47-15533; a Kenics-type mixer disclosed in Japanese Patent Application Laid-Opne (JP-A) No. 47-33166; and motionless mixers similar to those listed. In the case where the reaction section 13 does not contains a blending device, the reaction section 13 is composed of part of the pressure resistant pipeline 30. In this case, a shape of the pipeline 30 is not particularly limited, but it is preferably a spiral shape in view of down-sizing of the device.

To the reaction section 13, an inlet 13a configured to introduce the raw materials dissolved or melted in the contact section 9, and an inlet 13b, which is an example of a catalyst inlet configured to introduce the catalyst supplied from the tank 11 by the metering pump 12, are provided. In the present embodiment, each inlet (13a, 13b) is composed of a connector. The connector is not particularly limited, and selected from conventional connectors, such as reducers, couplings, Y, T, and outlets. Note that, a gas outlet configured to release evaporated products may be provided to the reaction section 13. Moreover, a heater 13c configured to heat the supplied raw materials is provided in the reaction section 13.

FIG. 4 illustrates an example where one reaction section 13 is provided, but two or more reaction sections can be provided. In the case where two or more reaction sections are used, the reaction (polymerization) conditions (e.g., temperature, catalyst concentration, pressure, average retention time, and stirring speed) for each reaction section may be identical, but it is preferred that optimal conditions for each reaction section be selected depending on the progress of the polymerization. Note that, it is not very good idea that excessively large number of containers is connected to give many stages, as it may extend a reaction time, or a device may become complicated. The number of stages is preferably 1 to 4, more preferably 1 to 3.

In the case where polymerization is performed by means of a device having a small number of reaction sections, it is typically believed that such device is not suitable for industrial productions, as a polymerization degree of an obtained polymer or an amount of monomer residues is unstable. It is considered that the instability thereof is caused because raw materials having the melt viscosity of a few poises to several tends poises and the polymerized polymer having the melt viscosity of approximately 1,000 poises are present together in the same container. On the other hand, the difference in viscosity inside the reaction section (polymerization system) can be reduced by melting the raw materials and the generated polymer in the present embodiment, and therefore a polymer can be stably produced with a reduced number of stages compared to a conventional polymerization reaction device.

The metering pump 14 of the polymerization reaction device main body 100b is configured to send a polymer obtained through polymerization in the reaction section 13 out to the blending device 41 at the predetermined blending device 41.

Subsequently, a blending device 41 of the complex production device 300 is explained with reference to FIG. 3. The blending device 41 is a device configured to mix the first polymer and second polymer obtained through polymerization performed each polymerization reaction device 100, to thereby obtain a polymer composition containing stereo complex crystals.

The polymer inlet 41a of the blending device 41 and the metering pump 14 of each polymerization reaction device 100 are connected with the pipeline 31 as illustrated in FIG. 3. As a result of this configuration, the polymer generated in each polymerization reaction device 100 is supplied to the blending device 41 in the melted state without being returned to atmospheric pressure. As each polymer can maintains a melted state of low viscosity, it is possible to mix the polymers in the blending device 41 at low temperature. Note that, FIG. 3 illustrates an example where two polymerization reaction devices 100 are aligned in parallel as the pipeline 31 contains one connector 31a, but three or more polymerization reaction devices 100 may be provided in parallel by providing a polarity of connectors.

The blending device 41 is not particularly limited, as long as it can mix a plurality of polymers supplied from the polymerization reaction devices 100, but it is preferably a device equipped with a stirring device. As for the stirring device, preferred are a single screw stirring device, a twin-screw stirring device where screws are engaged with each other, a biaxial mixer containing a plurality of stirring elements which are engaged or overlapped with each other, a kneader containing spiral stirring elements which are engaged with each other, and a static mixer. The temperature at which polymers are mixed in the blending device 41 (blending temperature) can be set to the same to the polymerization reaction temperature of the reaction section 13 of each polymerization reaction device 100. Note that, an inlet for a compressive fluid may be provided in the blending device 41 in order to further introduce a compressive fluid to the polymer to be mixed.

A pressure control valve 42 is provided at the edge of the blending device 41. The pressure control valve 42 is configured to discharge the polymer composition PP obtained by mixing in the blending device 41 from the blending device by utilizing the pressure difference between inside and outside of the blending device 41. Moreover, the pressure control valve 42 is configured to control a flow rate of the polymer composition PP obtained in the blending device 41, by controlling the opening degree of the pressure control valve 42.

### <Second Production Device>

A complex production device 400 as a second production device is explained with reference to FIG. 5 hereinafter. As illustrated in FIG. 5, the complex production device 400 contains a polymerization reaction device 100, which is the same or similar to that in FIG. 4, tanks (21, 27), a metering feeder 22, a metering pump 28, a contact section 29, and a reaction section 33.

The tank 21 is configured to store a ring-opening polymerizable monomer as a second monomer. The ring-opening polymerizable monomer to be stored may be a solid or liquid. The tank 27 is configured to store a compressive fluid. The compressive fluid to be stored in the tank 27 is not particularly limited, but it is preferably those same or similar to the compressive fluid stored in the tank 7 in order to carry out a polymerization reaction uniformly. Note that, the tank 27 may store gas or a solid that is transformed into a compressive fluid upon application of heat or pressure during the process for supplying to the contact section 29, or within the contact section 29. In this case, the gas or solid stored in the tank 27 is transformed in the state of (1), (2), or (3) of FIG. 2 in the contact section 29 upon application of heat or pressure.

The metering feeder 22 is configured to measure and continuously supply the second monomer stored in the tank 21 to the contact section 29. The metering pump 28 is configured to continuously supply the compressive fluid stored in the tank 27 to the contact section 29 at the constant pressure and constant flow rate.

The contact section 29 is a pressure resistant device or pipe configured to continuously bring the second monomer supplied from the tank 21 into contact with the compressive fluid supplied from the tank 27, to thereby melt or dissolve the second monomer. As a result of this, the second monomer can be supplied to the reaction section 33 with the melted or dissolved state. To the contact section 29, an inlet 29a configured to introduce the compressive fluid supplied from the tank 27 by the metering pump 28, and an inlet 29b configured to introduce the second monomer supplied from the tank 21 by the metering feeder 22 are provided. In the present embodiment, each inlet (29a, 29b) is composed of a connector. The connector is not particularly limited, and selected from conventional connectors, such as reducers, couplings, Y, T, and outlets. Note that, in the present embodiment, as for the structure of the contact section 29, the same or similar structure of the contact section 9 can be used, and therefore specific explanations thereof are omitted.

The reaction section 33 is composed of a pressure resistant device or pipe, configured to bring a polymer obtained as a melted or dissolved intermediate product in the reaction section 13 with a second monomer melted or dissolved in the contact section 29 to thereby continuously polymerize. To the reaction section 33, moreover, an inlet 33a configured to introduce a polymer as the aforementioned intermediate product, and an inlet 33b configured to introduce the melted or dissolved second monomer are provided.

The inlet 33a and the metering pump 14 of the polymerization reaction device 100 are connected with the pipeline 30 as illustrated in FIG. 5. As a result of this configuration, a polymer generated in each polymerization reaction device 100 can be supplied to the reaction section 33 in the melted state without turning back to the atmospheric pressure. As a result, the polymer can maintain the melted state of low viscosity, and therefore it is possible to polymerize the polymer with the second monomer in the reaction section 33 at low temperature.

In the present embodiment, each inlet (33a, 33b) is composed of a connector. The connector is not particularly limited, and selected from conventional connectors, such as reducers, couplings, Y, T, and outlets. Note that, in the present embodiment, the structure of the reaction section 33 is the same or similar to that of the reaction section 13, and thus specific explanations thereof are omitted.

A pressure control valve 34 is provided at the edge of the reaction section 33. The pressure control valve 34 is configured to discharge the polymer product P polymerized in the reaction section 33 by utilizing the pressure difference between inside and outside of the reaction section 33, out of the reaction section 33.

### <<Production Method>>

As a production method of a polymer composition containing stereo complex crystals, the first production method using the complex production device 300 and the second production method using the complex production device 400 are explained next. Note that, the first production method is a method in which polymerization of the first monomer and polymerization of the second monomer are carried out, respectively, followed by mixing polymers (homopolymers) as the obtained intermediate products. Moreover, the second production method is a method, in which polymerization of the first monomer is carried out first, the second monomer is added when the first monomer is consumed, and polymerization is carried out to thereby obtain a block copolymer.

### <First Production Method>

The first production method contains a polymerization step, that is, continuously supplying and bringing at least a ring-opening polymerizable monomer and a compressive fluid into contact with each other to react the ring-opening polymerizable monomer through ring-opening polymerization, to thereby continuously obtain a polymer in each polymerization reaction device 100. Moreover, the production method of the present embodiment contains a mixing step, which is mixing a plurality of the polymers obtained in the polymerization step in the presence of the compressive fluid, to thereby continuously obtain a polymer composition PP.

### (Polymerization Step)

The polymerization step in the polymer production method of the present embodiment is explained first. Each metering feeder (2, 4), the metering pump 6, and the metering pump 8 are operated. As a result, the ring-opening polymerizable monomer as the first monomer, the initiator, the additives, and the compressive fluid in the tanks (1, 3, 5, 7) are continuously supplied and introduced into the pipe of the contact section 9 from the respective inlets (9a, 9b, 9c, 9d). Note that, the weight accuracy of solid (powder or granular) raw materials may be low compared to that of the liquid raw materials. In this case, the solid raw materials may be melted to into a liquid to be stored in the tank 5, and then introduced into the pipe of the contact section 9 by the metering pump 6. The order for operating the metering feeders (2, 4) and the metering pump 6 and metering pump 8 are not particularly limited, but it is preferred that the metering pump 8 be operated first because there is a possibility that raw materials are solidified if the initial raw materials are sent to the reaction section 13 without being in contact with the compressive fluid.

The speed for feeding each of the raw materials by the respective metering feeder (2, 4) or metering pump 6 is adjusted based on the predetermined mass ratio of the ring-opening polymerizable monomer, initiator, and additives so that the mass ratio is kept constant. A total mass of each of the raw material supplied per unit time by the metering feeder (2, 4) or metering pump 6 (the feeding speed of the raw materials (g/min)) is adjusted based on desirable physical properties of a polymer or a reaction time. Similarly, a mass of the compressive fluid supplied per unit time by the metering pump 8 (the feeding speed of the compressive fluid (g/min)) is adjusted based on desirable physical properties of a polymer or a reaction time. The ratio (feeding speed of the raw material/feeding speed of the compressive fluid, referred to as a feeding ratio) of the feeding speed of the raw materials to the feeding speed of the compressive fluid is preferably 1 or greater, more preferably 3 or greater, even more preferably 5 or greater, and particularly preferably 10 or greater. The upper limit of the feeding ratio is preferably 1,000 or lower, more preferably 100 or lower, and even more preferably 50 or lower.

By setting the feeding ratio to 1 or greater, a reaction progresses with the high concentration of the raw materials and a polymer product (i.e., high solid content) when the raw materials and the compressive fluid are sent to the reaction section 13. The solid content in the polymerization system here is largely different from a solid content in a polymerization system where polymerization is performed by dissolving a small amount of a ring-opening polymerizable monomer in a significantly large amount of a compressive fluid in accordance with a conventional production method. The production method of the present embodiment is characterized by that a polymerization reaction progresses efficiently and stably in a polymerization system having a high solid content. Note that, in the present embodiment, the feeding ratio may be set to less than 1. In this case, economical efficiency is not satisfactory. When the feeding ratio is greater than 1,000, there is a possibility that the compressive fluid may not sufficiently dissolve the ring-opening polymerizable monomer therein, and the intended reaction may not be uniformly carried out.

Since the raw materials and the compressive fluid are each continuously introduced into the pipe of the contact section 9, they are continuously brought into contact with each other. As a result, each of the raw materials, such as the ring-opening polymerizable monomer, the initiator, and the additives, are melted or dissolved in the contact section 9. In the case where the contact section 9 contains a stirring device, the raw materials and compressive fluid may be stirred. In order to prevent the introduced compressive fluid from turning into gas, the internal temperature and pressure of the pipe of the contact section 9 are controlled to the temperature and pressure both equal to or higher than at least a triple point of the compressive fluid. The control of the temperature and pressure here is performed by adjusting the output of the heater 9e of the contact section 9, or adjusting the feeding rate of the compressive fluid. In the present embodiment, the temperature for melting the ring-opening polymerizable monomer may be the temperature equal to or lower than the melting point of the ring-opening polymerizable monomer under atmospheric pressure. It is assumed that the internal pressure of the contact section 9 becomes high under the influence of the compressive fluid so that the melting point of the ring-opening polymerizable monomer becomes lower than the melting point thereof under the atmospheric pressure. Accordingly, the ring-opening polymerizable monomer is melted in the contact section 9, even when an amount of the compressive fluid is small with respect to the ring-opening polymerizable monomer.

In order to melt or dissolve each of the raw materials efficiently, the timing for applying heat to or stirring the raw materials and compressive fluid in the contact section 9 may be adjusted. In this case, heating or stirring may be performed after bringing the raw materials and compressive fluid into contact with each other, or heating or stirring may be performed while bringing the raw materials and compressive fluid into contact with each other. To make melting of the materials even more certain, for example, the ring-opening polymerizable monomer and the compressive fluid may be brought into contact with each other after heating the ring-opening polymerizable monomer at the temperature equal to or higher than the melting point thereof. In the case where the contact section 9 is a biaxial mixing device, for example, each of the aforementioned aspects may be realized by appropriately setting an alignment of screws, arrangement of inlets (9a, 9b, 9c, 9d), and temperature of the heater 9e of the contact section 9.

In the present embodiment, the additives are supplied to the contact section 9 separately from the ring-opening polymerizable monomer, but the additives may be supplied together with ring-opening polymerizable monomer. Alternatively, the additives may be supplied after completion of a polymerization reaction. In this case, after taking the obtained polymer product out from the reaction section 13, the additive may be added to the polymer product while kneading the mixture of the additives and polymer product.

The raw materials melted or dissolved in the contact section 9 are each sent by the feeding pump 10, and supplied into the reaction section 13 from the inlet 13a. Meanwhile, the catalyst in the tank 11 is measured by the metering pump 12, and the predetermined amount thereof is supplied to the reaction section 13 through the inlet 13b. The catalyst can function even at room temperature, and therefore, in the present embodiment, the catalyst is added after melting the raw materials in the compressive fluid. In the conventional art, the timing for adding the catalyst has not been discussed in the ring-opening polymerization of the ring-opening polymerizable monomer using the compressive fluid. In the present embodiment, in the course of the ring-opening polymerization, the catalyst is added to the polymerization system in the reaction section 13 because of the high activity of the catalyst, where the polymerization system contains a mixture of raw materials such as the ring-opening polymerizable monomer and the initiator, sufficiently dissolved or melted in the compressive fluid. When the catalyst is added to the mixture in the state where the mixture is not sufficiently dissolved or melted, a reaction may unevenly progresses.

The raw materials each sent by the feeding pump 10 and the catalyst supplied by the metering pump 12 are optionally sufficiently mixed by the blending device of the reaction section 13, or heated to the predetermined temperature by the heater 13c when transported. As a result, ring-opening polymerization reaction of the ring-opening polymerizable monomer is carried out in the reaction section 13 in the presence of the catalyst, to thereby continuously obtain a polymer.

The lower limit of the temperature for ring-opening polymerization of the ring-opening polymerizable monomer (polymerization reaction temperature) is not particularly limited, but it is 40° C., preferably 50° C., and more preferably 60° C. When the polymerization reaction temperature is lower than 40° C., it may take a long time to melt the ring-opening polymerizable monomer in the compressive fluid, depending on the type of the ring-opening polymerizable monomer, or melting of the ring-opening polymerizable monomer may be insufficient, or the activity of the catalyst may be low. As a result, the reaction speed may be reduced during the polymerization, and therefore it may not be able to proceed to the polymerization reaction quantitatively.

The upper limit of the polymerization reaction temperature is not particularly limited, but it is either 150° C., or temperature that is higher than the melting point of the ring-opening polymerizable monomer by 50° C., whichever higher. The upper limit of the polymerization reaction temperature is preferably 100° C., or temperature that is higher than the melting point of the ring-opening polymerizable monomer by 30° C., whichever higher. The upper limit of the polymerization reaction temperature is more preferably 90° C., or the melting point of the ring-opening polymerizable monomer, whichever higher. The upper limit of the polymerization reaction temperature is even more preferably 80° C., or temperature that is lower than the melting point of the ring-opening polymerizable monomer by 20° C., whichever higher. When the polymerization reaction temperature is higher than the aforementioned temperature that is higher than the melting point of the ring-opening polymerizable monomer by 50° C., a depolymerization reaction, which is a reverse reaction of ring-opening polymerization, tends to be caused equilibrately, and therefore the polymerization reaction is difficult to proceed quantitatively. In the case where a ring-opening monomer having low melting point, such as a ring opening polymerizable monomer that is liquid at room temperature, is used, the polymerization reaction temperature may be temperature that is higher than the melting point by 50° C. or greater to enhance the activity of the catalyst. Even in this case, the polymerization reaction temperature is preferably 150° C. or lower. Note that, the polymerization reaction temperature is controlled by a heater 13c equipped with the reaction section 13, or by externally heating the reaction section 13. When the polymerization reaction temperature is measured, a polymer obtained by the polymerization reaction may be used for the measurement.

In a conventional production method of a polymer using supercritical carbon dioxide, polymerization of a ring-opening polymerizable monomer is carried out using a large amount of supercritical carbon dioxide, as supercritical carbon dioxide has low ability of dissolving a polymer. In accordance with the polymer production method of the present embodiment using a compressive fluid, ring-opening polymerization of a ring-opening polymerizable monomer is performed with a high concentration, which has not been realized in a conventional art. In this case, the internal pressure of the reaction section 13 becomes high under the influence of the compressive fluid, and thus glass transition temperature (Tg) of the generated polymer becomes low. As a result, the generated polymer has low viscosity, and therefore a ring-opening reaction uniformly progresses even in the state where the concentration of the polymer is high.

In the present embodiment, the polymerization reaction time (the average retention time in the reaction section 13) is appropriately set depending on a target molecular weight of a polymer product to be produced. Generally, the polymerization reaction time is preferably within 1 hour, more preferably within 45 minutes, and even more preferably within 30 minutes. The production method of the present embodiment can reduce the polymerization reaction time to 20 minutes or shorter. This polymerization reaction time is short, which has not been realized before in polymerization of a ring-opening polymerizable monomer in a compressive fluid.

The pressure for the polymerization, i.e., the pressure of the compressive fluid, may be the pressure at which the compressive fluid supplied by the tank 7 becomes a liquid gas ((2) in the phase diagram of FIG. 2), or high pressure gas ((3) in the phase diagram of FIG. 2), but it is preferably the pressure at which the compressive fluid becomes a supercritical fluid ((1) in the phase diagram of FIG. 2). By making the compressive fluid into the state of a supercritical fluid, melting of the ring-opening polymerizable monomer is accelerated to uniformly and quantitatively progress a polymerization reaction. In the case where carbon dioxide is used as the compressive fluid, the pressure is 3.7 MPa or higher, preferably 5 MPa or higher, more preferably 7.4 MPa or higher, which is the critical pressure or higher, in view of efficiency of a reaction and polymerization rate. In the case where carbon dioxide is used as the compressive fluid, moreover, the temperature thereof is preferably 25° C. or higher from the same reasons to the above.

The moisture content in the reaction section 13 is preferably 4 mol % or less, more preferably 1 mol % or less, and even more preferably 0.5 mol % or less, relative to the ring-opening polymerizable monomer. When the moisture content is greater than 4 mol %, it may be difficult to control a molecular weight of a resulting product as the moisture itself acts as an initiator. In order to control the moisture content in the polymerization system, an operation for removing moistures contained in the ring-opening polymerizable monomer and other raw materials may be optionally provided as a pretreatment.

In another polymerization reaction device 100 of the complex production device 300, the second monomer, which is an optical isomer of the first monomer, is polymerized to thereby continuously obtain a second polymer. The method for polymerizing the second monomer is the same as the method for polymerizing the first polymer, and therefore explanations thereof are omitted.

### (Mixing Step)

The mixing step is explained next. The first polymer or second polymer obtained through the polymerization performed in the respective polymerization reaction device 100 is sent by the metering pump 14, and is introduced into the blending device 41 from the polymer inlet 41a through the pipeline 31. The blending device 41 is configured to mix the introduced polymers, to thereby prepare a polymer composition PP. The internal temperature of the blending device 41 is preferably set to the temperature the same or similar to the polymerization reaction temperature by means of the heater 41c. When a polymer, such as polylactic acid, is heated to the temperature equal or higher than the melting point thereof, a ring-opening polymerizable monomer is generated by a depolymerization reaction. In the mixing step of the present embodiment, the polymer can be melted at temperature lower than the melting point thereof under the atmospheric pressure in the presence of the compressive fluid, and therefore a depolymerization reaction, racemization, and thermal deterioration can be prevented.

The polymer composition PP obtained in the blending device 41 is discharged outside the blending device 41 from the pressure control valve 42. The speed for discharging the polymer composition PP from the pressure control valve 42 is preferably constant to attain a uniform polymer composition. To this end, the feeding speeds of a feeding system of each reaction section 13, a feeding system of each contact section 9, each metering feeder (2, 4), and the metering pumps (6, 8) are controlled to maintain the back pressure of the pressure control valve 42 constant. The control system may be an ON-OFF control system, i.e., an intermittent feeding system, but it is in most cases preferably a continuous or stepwise control system where the rational speed of the pump or the like is gradually increased or decreased. Any of these controls realizes to stably provide a polymer composition PP.

The compressive fluid contained in the polymer composition PP discharged from the pressure control valve 42 is vaporized under the atmospheric pressure to be removed. Moreover, the first polymer and the second polymer contained in the polymer composition PP are both cooled to room temperature and are crystallized, to thereby obtain a polymer composition containing stereo complex crystals.

The catalyst remained in the polymer composition obtained in the present embodiment is removed, if necessary. A method for removing the catalyst is not particularly limited, but examples thereof include: vacuum distillation in case of a compound having a boiling point; a method for extracting and removing the catalyst using a compound dissolving the catalyst as an entrainer; and a method for absorbing the catalyst with a column to remove the catalyst. In the method for removing the catalyst, a system thereof may be a batch system where the polymer composition is taken out from the blending device 41 and then the catalyst is removed therefrom, or a continuous processing system where a process for removing the catalyst is continuously performed without taking the polymer composition out. In the case of vacuum distillation, the vacuum condition is set based on a boiling point of the catalyst. For example, the temperature in the vacuum is 100° C. to 120° C., and the catalyst can be removed at the temperature lower than the temperature at which the polymer composition is depolymerized. If an organic solvent is used in the extraction process, it may be necessary to provide a step for removing the organic solvent after extracting the catalyst. Therefore, it is preferred that a compressive fluid be used as a solvent for the extraction. As for the process of such extraction, conventional techniques used for extracting perfumes may be diverted.

As mentioned earlier, in accordance with the production of the present embodiment, it is possible to perform a polymerization reaction at low temperature, as a compressive fluid is used. Therefore a depolymerization reaction is significantly prevented, compared to a conventional polymerization reaction. Accordingly, the polymerization rates of the first monomer and the second monomer can achieve 98 mol % or greater, preferably 99 mol % or greater, more preferably 99.9 mol % or greater. When the polymerization rate is less than 96 mol %, the polymer composition does not have satisfactory thermal characteristics to function as a polymer composition, and therefore it may be necessary to separately provide an operation for removing a ring-opening polymerizable monomer. Note that, in the present embodiment, the polymerization rate is a ratio of an amount of the monomer contributed to the generation of a polymer to a total amount of the first monomer and second monomer as the raw materials. The amount of the monomer contributed to the generation of a polymer can be obtained by deducting a sum (ring-opening polymerizable monomer residue amount) of an amount of the first monomer remained in the polymer and an amount of the second monomer remained in the polymer from an amount of the generated polymer.

### <Second Production Method>

The second production method using the complex production device 400 is explained next. The production method of the present embodiment contains a first polymerization step, which is continuously supplying and bringing at least a first monomer as a ring-opening polymerizable monomer, and a compressive fluid into contact with each other to allow the first monomer to react through ring-opening polymerization, to thereby continuously obtain an intermediate product. Moreover, the production method of the present embodiment contains a second polymerization step, which is bringing the intermediate product into contact with a second monomer, to thereby polymerize the intermediate product and the second monomer.

### (First Polymerization Step)

The first polymerization step in the second production method is the same as the polymerization step for polymerizing the first monomer using one polymerization reaction device 100. Therefore, specific explanations of the first polymerization step are omitted.

### (Second Polymerization Step)

The second polymerization step in the second production method is explained next. In this step, first, the metering feeder 22 and the metering pump 28 are operated to continuously supply the second monomer and the compressive fluid in respective tanks tank (21, 27), to thereby introduce the second monomer and the compressive fluid into the pipe of the contact section 29 from the respective inlets (29a, 29b). Since the second monomer and the compressive fluid are continuously introduced into the pipe of the contact section 29, the second monomer and the compressive fluid are continuously brought into contact with each other. As a result, the second monomer is melted or dissolved in the contact section 29. Note that, the order and condition for introducing the second monomer and the compressive fluid in the second polymerization step are the same as those in the first polymerization step, and therefore specific explanations thereof are omitted.

In the present embodiment, a ratio between an amount (feeding rate) of the ring-opening polymerizable monomer supplied by the metering feeder 2 per unit time in the first polymerization step and an amount (feeding rate) of the ring-opening polymerizable monomer supplied by the metering feeder 22 per unit time in the second polymerization step is not particularly limited, and an amount of the monomer supplied by each feeder can be determined based on a ratio of a target molecular weights of resulting blocks.

The polymer as an intermediate product generated in the reaction section 13 in the melted or dissolved state is continuously supplied into the reaction section 33 from the inlet 33a. Meanwhile, the second monomer melted or dissolved in the contact section 29 is continuously supplied into the reaction section 33 from the inlet 33b. As a result, the polymer as the intermediate product and the second monomer are continuously brought into contact with each other in the reaction section 33. The polymer as the intermediate product and the second monomer are sufficiently stirred by a stirring device of the reaction section 33, and are heated to certain temperature by the heater 33c. As a result, the polymer as the intermediate product and the second monomer are polymerized in the reaction section 33 in the presence of the catalyst contained in the polymer as the intermediate product, to thereby obtain a polymer as a final product. The conditions for polymerization performed in the reaction section 33, such as temperature, duration, and pressure are not particularly limited, but they are set similarly to the conditions in the reaction section 13.

The polymer product P obtained after completing the ring-opening polymerization reaction in the reaction section 33 is discharged outside the reaction section 33 from the pressure control valve 34. The speed for discharging the polymer product P from the pressure control valve 34 is preferably constant so as to keep the internal pressure of the polymerization system filled with the compressive fluid constant, and to yield a uniform polymerization product. The feeding speeds of the feeding systems inside the reaction sections (13, 33), the feeding systems inside the contact sections (2, 29), metering feeders (2, 4, 22), and metering pumps (6, 8, 28) are controlled to maintain the back pressure of the pressure control valve 34 constant.

In the second production method, a block copolymer containing stereo complex crystals can be synthesized. In this method, a reaction is carried out at temperature equal to or lower than the melting point of the ring-opening polymerizable monomer with a small amount of the ring-opening polymerizable monomer, and therefore racemization is hardly occurred, and the copolymer is obtained through a continuous reaction. Accordingly, this method is extremely useful.

### <<Polymer Composition>>

The polymer composition obtained by the aforementioned production method contains stereo complex crystals, and substantially no organic solvent, and an amount of the ring-opening polymerizable monomer residues is 2 mol % or less. Note that, a “stereo complex crystal” is a crystal containing a pair of components (e.g., a poly-D-lactic acid component and a poly-L-lactic acid component) that are optical isomers. In the present embodiment, the stereo complex crystallization degree (S) represented by the following formula (i) is preferably 90% or greater, more preferably 95% or greater.

(S)=[ΔHmsc/(ΔHmh+ΔHmsc)]×100 (i)

In the formula (i), ΔHmh is heat of melting (J/g) of a homocrystal that does not contribute to formation of a stereo complex crystal, which is, for example, observed at lower than 190° C. in case of polylactic acid. Moreover, ΔHmsc is heat of melting (J/g) of a stereo complex crystal, which is, for example, observed at 190° C. or higher in case of polylactic acid. Note that, in the case where the stereo complex crystallization degree is less than 90%, an influence of homocrystals on a melting point may not be a level that cannot be ignored. In the case where the polymer composition is polylactic acid, a mass ratio of a poly-D-lactic acid component to a poly-L-lactic acid component is preferably 90/10 to 10/90, more preferably 40/60 to 60/40, for achieving the aforementioned parameter of the crystallization degree.

### <Ring-Opening Polymerizable Monomer Residue Amount>

An amount of the ring-opening polymerizable monomer residues can be calculated, for example, from a ratio of a peak area originated from a ring-opening polymerizable monomer to a peak area originated from a polymer, which are obtained by ¹H-NMR.

A specific method thereof is as follows.

<<Case where Ring-Opening Polymerizable Monomer is Lactide>>

Nuclear magnetic resonance (NMR) spectroscopy of polylactic acid as a polymer composition is performed in deuterated chloroform by means of a nuclear magnetic resonance apparatus JNM-AL300 manufactured by JEOL Ltd. In this case, a ratio of a quartet peak area attributed to lactide (4.98 ppm to 5.05 ppm) to a quartet peak area attributed to polylactic acid (5.10 ppm to 5.20 ppm) is calculated, and an value obtained by multiplying the calculated value with 100 is determined as an amount of the ring-opening polymerizable monomer residues (mol %).

The polymer composition obtained in the present embodiment is produced by the production method that does not use an organic solvent. Therefore, the polymer composition is substantially free from an organic solvent, and has an extremely small ring-opening polymerizable monomer residue amount, which is 2 mol % or less (polymerization rate: 98 mol % or greater), preferably 1 mol % or less (polymerization rate: 99 mol % or greater), more preferably 1,000 mol ppm or less (polymerization rate: 99.9 mol % or greater). Accordingly, the polymer composition excels in its safety and stability. Accordingly, the polymer composition can be widely used in various use, such as commodities, medical products, cosmetic products, and electrophotographic toner.

Note that, in the present embodiment, the organic solvent is an organic matter solvent used for ring-opening polymerization, and dissolves a polymer obtained through a ring-opening polymerization. In the case where the polymer composition is stereo complex-type polylactic acid, examples of the organic solvent include a halogen solvent (e.g., chloroform, and methylene chloride) and tetrahydrofuran. The phrase “substantially free from an organic solvent” means an amount of an organic solvent in a polymer product is a detection limit or lower when the amount thereof is measured by the following measuring method.

### (Measuring Method of Residual Organic Solvent)

To 1 part by mass of the polymer composition that is a subject of a measurement, 2 parts by mass of 2-propanol is added, and the resulting mixture is dispersed for 30 minutes by applying ultrasonic waves, followed by storing the resultant over 1 day or longer in a refrigerator (5° C.) to thereby extract the organic solvent in the polymer composition. A supernatant liquid thus obtained is analyzed by gas chromatography (GC-14A, SHIMADZU) to determine quantities of the organic solvent and monomer residues in the polymer composition, to thereby measure a concentration of the organic solvent. The measuring conditions for the analysis are as follows.

### Device: SHIMADZU GC-14A

### Column: CBP20-M 50-0.25

### Detector: FID

Injection amount: 1 μL to 5 μL
Carrier gas: He, 2.5 kg/cm²
Flow rate of hydrogen: 0.6 kg/cm²
Flow rate of air: 0.5 kg/cm²
Chart speed: 5 mm/min

### Sensitivity: Range 101×Atten 20

Temperature of column: 40° C.
Injection temperature: 150° C.

In the case where a polymer composition is obtained by heating to higher temperature equal to or higher the melting point of a monomer to melt in accordance with a conventional production method, heat deterioration is caused, and as a result, the obtained polymer is turned yellow. On the other hand, the polymer composition of the present embodiment has a less amount of ring-opening polymerization monomer residues, and is obtained through a polymerization at low temperature, because of which discoloration, mainly yellowing, can be inhibited, and hence the polymer composition is white in color. Note that, the degree of yellowing can be evaluated with the value of YI, which is determined by preparing a 2 mm-thick resin pellet, and measuring the pellet by means of a SM color computer (manufactured by Suga Test Instruments Co., Ltd.) in accordance with JIS-K7103. In the present embodiment, the polymer product being white means that the polymer product has the YI value of 5 or lower.

The weight average molecular weight of the polymer composition obtained in the present embodiment can be controlled by an amount of the initiator. The weight average molecular weight of the polymer composition is not particularly limited, but it is typically 12,000 to 200,000. When the weight average molecular weight thereof is greater than 200,000, productivity is low because of the increased viscosity, which is not economically advantageous. When the weight average molecular weight thereof is smaller than 12,000, it may not be preferable because a polymer composition may have insufficient strength to function as a polymer composition. The value obtained by dividing the weight average molecular weight Mw of the polymer composition obtained in the present embodiment with the number average molecular weight Mn thereof is preferably 1.0 to 2.5, more preferably 1.0 to 2.0. When the value thereof is greater than 2.0, it is not preferable as the polymerization reaction may have progressed non-uniformly to produce a polymer composition, and therefore it is difficult to control physical properties of the polymer.

In the present embodiment, in the case where the polymerization is carried out using an organic catalyst containing no metal atom, a polymer composition containing substantially no metal atom is obtained. The phrase “containing substantially no metal atom” means that a metal atom originated from a metal catalyst is not contained. Specifically, it can be said that the metal atom originated from a metal catalyst is not contained when a result is a detection limit or lower, as it is attempted to detect the metal atom originated from a metal catalyst in the polymer composition by a conventional analysis method, such as ICP-AES, atomic absorption spectrophotometry, and colorimetry. Examples of the metal atom originated from a metal catalyst include tin, aluminum, titanium, zirconium, and antimony.

### <<Use of Polymer Composition>>

The polymer composition obtained by the production method of the present embodiment is produced by a method without using an organic solvent, and has a small amount of monomer residues, and therefore the polymer composition excels in its safety and stability. Accordingly, the polymer composition obtained by the production method of the present embodiment can be widely applied for various use, such as an electrophotographic developer, a printing ink, a coating for buildings, a cosmetic product, and a medical material. Various additives may be used for the polymer composition in order to improve moldability, fabrication quality, degradability, tensile strength, heat resistance, storage stability, crystallinity, and weather fastness.

### Effects of Present Embodiment

In the present embodiment, a polymer is continuously obtained by continuously supplying at least a ring-opening polymerizable monomer and a compressive fluid, bringing into contact the ring-opening polymerizable monomer with the compressive fluid, and allowing the ring-opening polymerizable monomer to react through ring-opening polymerization. In this case, the progress of the reaction is slow at the upstream side of the feeding path of the reaction section 13 of the polymerization reaction device main body 100b, and therefore the viscosity within the system is low. The progress of the reaction is fast at the downstream side thereof, and therefore the viscosity within the system is high. As a result, a local viscosity variation is not generated and therefore the reaction is accelerated. Accordingly, the time required for the polymerization reaction is shortened compared to a conventional batch-system reaction.

Moreover, in accordance with the polymerization method of the present embodiment, it is possible to provide a polymer composition having excellent mold formability and thermal stability at low cost, with low environmental load, energy saving, and excellent energy saving, because of the following reasons.

(1) A reaction proceeds at low temperature compared to a melt polymerization method in which a reaction is proceeded at high temperature (e.g., 150° C. or higher);
(2) As the reaction proceeds at low temperature, a side reaction hardly occurs, and thus a polymer can be obtained at high yield relative to an amount of the ring-opening polymerizable monomer added (namely, an amount of unreacted ring-opening polymerizable monomer is small). Accordingly, a purification step for removing unreacted ring-opening polymerizable monomer residues, which is performed for attaining a polymer having excellent mold formability and thermal stability, can be simplified, or omitted.
(3) As a metal-free organic compound can be selected as a catalyst for use in the production of a polymer, intended use of which does not favor inclusion of a certain metal, it is not necessary to provide a step for removing the catalyst.
(4) In a polymerization method using an organic solvent, it is necessary to provide a step for removing a solvent to thereby yield a polymer composition as a solid. Moreover, it is difficult to completely remove the organic solvent, even when the step for removing the organic solvent is performed. In the polymerization method of the present embodiment, the step for removing the organic solvent can be omitted, as a waste liquid is not generated due to use of a compressive fluid, and a dry polymer composition can be obtained by a one-stage step.
(5) As the compressive fluid is used, a ring-opening polymerization reaction can be performed without an organic solvent.
(6) A uniform proceeding of a polymerization can be achieved because ring-opening polymerization is carried out by adding a catalyst after melting the ring-opening polymerizable monomer with the compressive fluid. Accordingly, the method of the present embodiment can be suitably used when optical isomers or copolymers with other monomers are produced.

### EXAMPLES

The present embodiment will be more specifically explained through Examples and Comparative Examples hereinafter, but Examples shall not be construed as to limit the scope of the present invention. Note that, physical properties of polymer compositions obtained in Examples and Comparative Examples were obtained in the following manners.

### <Measurement of Molecular Weight of Polymer Composition>

The measurement was performed by means of GPC (Gel Permeation Chromatography) under the following conditions.

Apparatus: GPC-8020 (product of TOSOH CORPORATION)
Column: TSK G2000HXL and G4000HXL (product of TOSOH CORPORATION)

### Temperature: 40° C.

Solvent: HFIP (hexafluoroisopropanol)
Flow rate: 1.0 mL/min

A polymer composition sample (1 mL) having a polymer concentration of 0.5% by mass was injected, and measured under the above-described conditions, to thereby obtain a molecular weight distribution of the polymer composition. Using a molecular weight calibration curve prepared from a monodispersed polystyrene standard sample, a number average molecular weight Mn of the polymer composition and a weight average molecular weight Mw of the polymer composition were calculated from the obtained molecular weight distribution. The molecular weight distribution is a value calculated by dividing Mw with Mn.

### <Amount of Ring-Opening Polymerizable Monomer Residues>

Nuclear magnetic resonance (NMR) spectroscopy of polylactic acid as the polymer composition was performed by means of a nuclear magnetic resonance apparatus (JNM-AL300, of JEOL Ltd.) in deuterated chloroform. In this case, a ratio of a quartet peak area attributed to lactide (4.98 ppm to 5.05 ppm) to a quartet peak area attributed to polylactic acid (5.10 ppm to 5.20 ppm) was calculated, and a value obtained by multiplying the calculated value with 100 was determined as an amount of ring-opening polymerizable monomer residues (mol %).

### <Stereo Complex Crystallization Degree>

The polymer composition was subjected to differential scanning calorimetry in the nitrogen atmosphere by means of a differential scanning calorimeter Q2000, manufactured by TA Instruments Japan Inc. As a sample, about 5 mg to about 10 mg of the polymer composition was used, and the sample was sealed in an aluminum pan. In a first cycle, the sample was heated to 250° C. at the rate of 10° C./min under a nitrogen gas flow, to thereby measure glass transition temperature (Tg), melting temperature (Tm*), heat of melting of a stereo complex crystal (ΔHmsc: J/g), and heat of melting of a homocrystal (ΔHmh: J/g).

### <Yellow Index (YI) Value>

The obtained polymer composition was formed into a resin pellet having a thickness of 2 mm, and a YI value thereof was measured by means of an SM color computer (manufactured by Suga Test Instruments Co., Ltd.) in accordance with JIS-K7103.

### Example 1

Polylactic acid having stereo complex crystals was produced by means of a complex production device 300 having a plurality of polymerization reaction devices 100, illustrated in FIGS. 3 and 4. The structure of the complex production device 300 was as follows.

### Tank 1, Metering Feeder 2:

Plunger pump NP-S462, manufactured by Nihon Seimitsu Kagaku Co., Ltd.

The tank 1 was charged with melted lactide as a ring-opening polymerizable monomer. Note that, the tank 1 of one polymerization reaction device 100 was charged with L-lactide (manufacturer: Purac, melting point: 100° C.), and the tank 1 of the other polymerization reaction device 100 was charged with D-lactide (manufacturer: Purac, melting point: 100° C.).

### Tank 3, Metering Feeder 4:

Intelligent HPLC pump (PU-2080), manufactured by JASCO Corporation

The tank 3 was charged with lauryl alcohol as an initiator.

Tank 5, Metering Pump 6: Not used in Example 1
Tank 7: Carbonic acid gas cylinder

### Tank 11, Metering Pump 12:

Intelligent HPLC pump (PU-2080), manufactured by JASCO Corporation

The tank 11 was charged with 1,8-diazabicyclo[5.4.0]undec-7-ene (DBU, manufacturer: Tokyo Chemical Industry Co., Ltd.) (organic catalyst).

Contact section 9: A ⅛-inch pressure resistant pipeline without a stirring function.
Reaction section 13: A ⅛-inch pressure resistant pipeline without a stirring function.
Blending device 41: A biaxial stirring device equipped with screws engaged with each other.

Inner diameter of cylinder: 40 mm

Identical biaxial rotational directions

Rotational speed: 30 rpm

The metering feeder 2 of the polymerization reaction device 100 of FIG. 4 was operated to supply L-lactide stored as a first monomer in the tank 1 to the pipeline of the contact section 9 at the feeding speed of 10 g/min. Moreover, the metering feeder 4 was operated to supply lauryl alcohol in the tank 3 to the pipeline of the contact section 9 at the constant rate so that the amount of the lauryl alcohol became 0.5 moles relative to 99.5 moles of lactide. Furthermore, the metering pump 8 was operated to continuously supply carbonic acid gas in the tank 7 to the pipeline of the contact section 9 so that the amount of the carbonic acid gas supplied per unit time became 5 parts by mass relative to 100 parts by mass of the raw materials. Specifically, the feeding ratio was set as follow:

Feeding ratio=[feeding speed of raw materials (g/min)]/[feeding speed of compressive fluid (g/min)]=100/5=20.

Note that, the raw materials were lactide serving as the ring-opening polymerizable monomers, and lauryl alcohol added as the initiator. Note that, the feeding speed of the raw materials was 10 g/min. The internal pressure of the polymerization system was controlled to 15 MPa. Moreover, the set temperature adjacent to the inlet 9a of the raw materials in the contact section 9 was 100° C., and the set temperature adjacent to the outlet of the melt-blended raw materials was 60° C. As a result, the contact section 9 continuously brought into contact the raw materials (L-lactide, and lauryl alcohol) and a compressive fluid supplied from each tank (1, 3, 7) to each other, blending and mixing these materials.

The raw materials each melted in the contact section 9 were fed into the reaction section 13 by the feeding pump 10. A polymerization catalyst (DBU) stored in the tank 11 was introduced by the metering pump 12 into the reaction section 13 in an amount of 0.1 mol relative to 99.9 mol of lactide, to thereby perform ring-opening polymerization of L-lactide in the presence of DBU. The temperature adjacent to the inlet 13a of the reaction section 13 was set to 60° C., the temperature of the end portion was set to 60° C., and the average retention time of each raw material in the reaction section 13 was controlled to about 1,200 seconds.

Moreover, ring-opening polymerization of D-lactide as a second monomer was performed using another polymerization reaction device 100 illustrated in FIG. 4. The operations thereof were the same as the operations for performing the ring-opening polymerization of L-lactide in the one polymerization reaction device 100.

Polymers (poly-L-lactide, poly-D-lactide) each obtained in the respective polymerization reaction devices 100 were continuously supplied, in the melted state, directly into the blending device 41 by the respective metering pumps 14 in the presence of a compressive fluid. The supplied both polymers were continuously mixed by means of the blending device 41 under the conditions as depicted in Table 1, to thereby obtain polylactic acid having stereo complex crystals. The values for physical properties of the obtained polylactic acid were determined in the aforementioned manners. The results are presented in Table 1. Note that, in Table 1, the “line 1” represents one polymerization reaction device 100, and the “line 2” represents the other polymerization reaction device 100.

### Examples 2 to 3

Polylactic acid was obtained in the same manner as in Example 1, provided that an amount of the initiator was changed.

The values for physical properties of the obtained polylactic acid were determined in the aforementioned manners. The results are presented in Table 1.

### Examples 4 to 5

Polylactic acid was obtained in the same manner as in Example 1, provided that a ratio of the feeding amount of the monomer of L-form and the feeding amount of the monomer of D-form was changed. The values for physical properties of the obtained polylactic acid were determined in the aforementioned manners. The results are presented in Table 2.

### Examples 6 to 7

Polylactic acid was obtained in the same manner as in Example 1, provided that the feeding ratio was changed. The values for physical properties of the obtained polylactic acid were determined in the aforementioned manners. The results are presented in Table 2.

### Example 8

Polylactic acid was obtained in the same manner as in Example 1, provided that tin di(2-ethylhexylate) was used as the catalyst, and temperature for the reaction and the mixing was changed. The values for physical properties of the obtained polylactic acid were determined in the aforementioned manners. The results are presented in Table 3. Note that, “tin” in Table 3 denotes tin di(2-ethylhexylate).

### Examples 9 to 10

Polylactic acid was obtained in the same manner as in Example 8, provided that an amount of the catalyst was changed. The values for physical properties of the obtained polylactic acid were determined in the aforementioned manners. The results are presented in Table 3.

### Comparative Example 1

Polylactic acid was obtained in the same manner as in Example 8, provided that the amount of the catalyst, temperature was changed, and the polymerization was performed without adding the compressive fluid. The values for physical properties of the obtained polylactic acid were determined in the aforementioned manners. The results are presented in Table 3.

TABLE 1

| | | | Ex. 1 | | Ex. 2 | | Ex. 3 | |
|---|---|---|---|---|---|---|---|---|
| | | | Line 1 | Line 2 | Line 1 | Line 2 | Line 1 | Line 2 |
| Monomer | | | L-lactide | D-lactide | L-lactide | D-lactide | L-lactide | D-lactide |
| Initiator amount | | | 0.5 | 0.5 | 1.0 | 1.0 | 0.25 | 0.25 |
| Catalyst | | | DBU | DBU | DBU | DBU | DBU | DBU |
| Polymerization | Raw materials | | 10 | 10 | 10 | 10 | 10 | 10 |
| | feeding rate | | | | | | | |
| | (g/min) | | | | | | | |
| | Feeding ratio | | 20 | 20 | 20 | 20 | 20 | 20 |
| | Set | Adjacent | 100 | 100 | 100 | 100 | 100 | 100 |
| | temp. | to inlet | | | | | | |
| | | 9a (° C.) | | | | | | |
| | | Adjacent | 60 | 60 | 60 | 60 | 60 | 60 |
| | | to outlet | | | | | | |
| | | (° C.) | | | | | | |

| | | | | | | |
|---|---|---|---|---|---|---|
| Internal pressure | 15 | 15 | 15 | 15 | 15 | 15 |
| of cylinder (MPa) | | | | | | |
| Average | 1,200 | 1,200 | 1,200 | 1,200 | 1,200 | 1,200 |
| retaining time | | | | | | |
| (sec.) | | | | | | |

| | | | | | |
|---|---|---|---|---|---|
| Mixing | Set | Adjacent | 60 | 60 | 60 |
| | temp. | to inlet | | | |
| | | 41a (° C.) | | | |
| | | Adjacent | 60 | 60 | 60 |
| | | to outlet | | | |
| | | (° C.) | | | |

| | | | |
|---|---|---|---|
| Internal pressure | 15 | 15 | 15 |
| of cylinder (MPa) | | | |
| Average | 600 | 600 | 600 |
| retaining time | | | |
| (sec.) | | | |

| | | | |
|---|---|---|---|
| Mw | 32,000 | 28,000 | 70,000 |
| Molecular weight | 1.8 | 2.1 | 1.9 |
| distribution (Mw/Mn) | | | |
| Ring-opening | 0.3 | 0.5 | 0.9 |
| polymerizable | | | |
| monomer residue | | | |
| amount (mol %) | | | |
| Stereo complex | 100 | 100 | 100 |
| crystallization degree (%) | | | |
| Yellow Index value | 2.2 | 1.5 | 2.0 |

TABLE 2

| | | | Ex. 4 | | Ex. 5 | | Ex. 6 | | Ex. 7 | |
|---|---|---|---|---|---|---|---|---|---|---|
| | | | Line 1 | Line 2 | Line 1 | Line 2 | Line 1 | Line 2 | Line 1 | Line 2 |
| Monomer | | | L-lactide | D-lactide | L-lactide | D-lactide | L-lactide | D-lactide | L-lactide | D-lactide |
| Initiator amount | | | 0.5 | 0.5 | 0.5 | 0.5 | 0.5 | 0.5 | 0.5 | 0.5 |
| Catalyst | | | DBU | DBU | DBU | DBU | DBU | DBU | DBU | DBU |
| Polymerization | Raw materials | | 8 | 10 | 10 | 8 | 10 | 10 | 10 | 10 |
| | feeding rate | | | | | | | | | |
| | (g/min) | | | | | | | | | |
| | Feeding ratio | | 20 | 20 | 20 | 20 | 10 | 10 | 5 | 5 |
| | Set | Adjacent | 100 | 100 | 100 | 100 | 100 | 100 | 100 | 100 |
| | temp. | to inlet | | | | | | | | |
| | | 9a (° C.) | | | | | | | | |
| | | Adjacent | 60 | 60 | 60 | 60 | 60 | 60 | 60 | 60 |
| | | to outlet | | | | | | | | |
| | | (° C.) | | | | | | | | |

| | | | | | | | | |
|---|---|---|---|---|---|---|---|---|
| Internal pressure | 15 | 15 | 15 | 15 | 15 | 15 | 15 | 15 |
| of cylinder (MPa) | | | | | | | | |
| Average retaining | 1,200 | 1,200 | 1,200 | 1,200 | 1,200 | 1,200 | 1,200 | 1,200 |
| time (sec.) | | | | | | | | |

| | | | | | | |
|---|---|---|---|---|---|---|
| Mixing | Set | Adjacent | 60 | 60 | 60 | 60 |
| | temp. | to inlet | | | | |
| | | 41a (° C.) | | | | |
| | | Adjacent | 60 | 60 | 60 | 60 |
| | | to outlet | | | | |
| | | (° C.) | | | | |

| | | | | |
|---|---|---|---|---|
| Internal pressure | 15 | 15 | 15 | 15 |
| of cylinder (MPa) | | | | |
| Average retaining | 600 | 600 | 600 | 600 |
| time (sec.) | | | | |

| | | | | |
|---|---|---|---|---|
| Mw | 34,000 | 21,000 | 36,000 | 34,000 |
| Molecular weight | 1.8 | 2.1 | 1.8 | 1.9 |
| distribution (Mw/Mn) | | | | |
| Ring-opening | 0.7 | 0.5 | 0.5 | 0.8 |
| polymerizable | | | | |
| monomer residue | | | | |
| amount (mol %) | | | | |
| Stereo complex | 95 | 90 | 100 | 100 |
| crystallization degree (%) | | | | |
| Yellow Index value | 1.2 | 0.8 | 0.5 | 1.2 |

TABLE 3

| | | | Ex. 8 | | Ex. 9 | | Ex. 10 | | Comp. Ex. 1 | |
|---|---|---|---|---|---|---|---|---|---|---|
| | | | Line 1 | Line 2 | Line 1 | Line 2 | Line 1 | Line 2 | Line 1 | Line 2 |
| Monomer | | | L-lactide | D-lactide | L-lactide | D-lactide | L-lactide | D-lactide | L-lactide | D-lactide |
| Initiator amount | | | 0.5 | 0.5 | 0.25 | 0.25 | 0.1 | 0.1 | 0.1 | 0.1 |
| Catalyst | | | tin | tin | tin | tin | tin | tin | tin | tin |
| Polymerization | Raw materials | | 10 | 10 | 10 | 10 | 10 | 10 | — | — |
| | feeding rate | | | | | | | | | |
| | (g/min) | | | | | | | | | |
| | Feeding ratio | | 20 | 20 | 20 | 20 | 20 | 20 | — | — |
| | Set | Adjacent | 150 | 150 | 150 | 150 | 150 | 150 | 200 | 200 |
| | temp. | to inlet | | | | | | | | |
| | | 9a (° C.) | | | | | | | | |
| | | Adjacent | 150 | 150 | 150 | 150 | 150 | 150 | 200 | 200 |
| | | to outlet | | | | | | | | |
| | | (° C.) | | | | | | | | |

| | | | | | | | | |
|---|---|---|---|---|---|---|---|---|
| Internal pressure | 15 | 15 | 15 | 15 | 15 | 15 | 15 | 15 |
| of cylinder (MPa) | | | | | | | | |
| Average retaining | 1,200 | 1,200 | 1,200 | 1,200 | 1,200 | 1,200 | 1,200 | 1,200 |
| time (sec.) | | | | | | | | |

| | | | | | | |
|---|---|---|---|---|---|---|
| Mixing | Set | Adjacent | 60 | 60 | 60 | 250 |
| | temp. | to inlet | | | | |
| | | 41a (° C.) | | | | |
| | | Adjacent | 60 | 60 | 60 | 250 |
| | | to outlet | | | | |
| | | (° C.) | | | | |

| | | | | |
|---|---|---|---|---|
| Internal pressure | 15 | 15 | 15 | 15 |
| of cylinder (MPa) | | | | |
| Average retaining | 600 | 600 | 600 | 600 |
| time (sec.) | | | | |

| | | | | |
|---|---|---|---|---|
| Mw | 36,000 | 110,000 | 230,000 | 180,000 |
| Molecular weight | 2.0 | 1.9 | 2.1 | 2.1 |
| distribution (Mw/Mn) | | | | |
| Ring-opening | 0.5 | 1.5 | 1.2 | 3.4 |
| polymerizable | | | | |
| monomer residue | | | | |
| amount (mol %) | | | | |
| Stereo complex | 100 | 100 | 100 | 80 |
| crystallization degree (%) | | | | |
| Yellow Index value | 1.6 | 2.5 | 0.8 | 6.5 |

### Example 2-1

A stereo block copolymer was obtained through ring-opening polymerization by successively adding L-lactide and D-lactide by means of the complex production device 400 of FIG. 5. The structure of the complex production device 400 was as follows.

### Tank 1, Metering Feeder 2:

Plunger pump NP-S462, manufactured by Nihon Seimitsu Kagaku Co., Ltd.

The tank 1 was charged with a 99:1 (molar ratio) mixture composed of lactide (L-lactide, manufacturer: Purac, melting point: 100° C.) (first monomer) as a ring-opening polymerizable monomer, and lauryl alcohol as an initiator. Note that, lactide was turned into a liquid state by heating lactide to temperature equal or higher than the melting point of lactide in the tank 1.

Tank 3, Metering feeder 4: Not used in Example 2-1
Tank 5, Metering pump 6: Not used in Example 2-1
Tank 7: Carbonic acid gas cylinder
Tank 27: Carbonic acid gas cylinder
Tank 21, Metering feeder 22:

Plunger pump NP-S462, manufactured by Nihon Seimitsu Kagaku Co., Ltd.

The tank 21 was charged with lactide (D-lactide, manufacturer: Purac, melting point: 100° C.)(second monomer) as a ring-opening polymerizable monomer. Note that, lactide was turned into the liquid state by heating lactide to temperature equal or higher than the melting point of lactide in the tank 21.

Tank 11, Metering pump 12:

Intelligent HPLC pump (PU-2080), manufactured by JASCO Corporation

The tank 11 was charged with 1,8-diazabicyclo[5.4.0]undec-7-ene (DBU, manufacturer: Tokyo Chemical Industry Co., Ltd.)(organic catalyst).

Contact section 9: A biaxial stirring device equipped with screws engaged with each other

Inner diameter of cylinder: 30 mm

Identical biaxial rotational directions

Rotational speed: 30 rpm

Contact section 29: A biaxial stirring device equipped with screws engaged with each other

Inner diameter of cylinder: 30 mm

Identical biaxial rotational directions

Rotational speed: 30 rpm

Reaction section 13: A two-axial kneader

Inner diameter of cylinder: 40 mm

Identical biaxial rotational directions

Rotational speed: 60 rpm

Reaction section 33: A two-axial kneader

Inner diameter of cylinder: 40 mm

Identical biaxial rotational directions

Rotational speed: 60 rpm

The metering feeder 2 was operated to continuously supply the raw materials (L-lactide and lauryl alcohol) in the tank 1 to the biaxial stirring device of the contact section 9 at the feeding speed of 10 g/min. Moreover, the metering pump 8 was operated to continuously supply carbonic acid gas in the tank 7 into the biaxial stirring device of the contact section 9 so that an amount of the carbonic acid gas was 5 parts by mass relative to 100 parts by mass of the raw materials. As a result, the raw materials including lactide and lauryl alcohol and the compressive fluid were continuously brought into contact with each other in the biaxial stirring device of the contact section 9, to melt the raw materials. Note that, the feeding ratio (feeding speed of the raw materials/feeding speed of the compressive fluid) in the contact section 9 was 20.

The raw materials melted in the contact section 9 were fed into the two-axial kneader of the reaction section 13 by the feeding pump 10. Meanwhile, the metering pump 12 was operated to supply a polymerization catalyst (DBU) stored in the tank 11 into the reaction section 13 so that a molar ratio of the catalyst to lactide was to be 99:1. As a result, ring-opening polymerization of lactide was continuously performed in the reaction section 13 in the presence of DBU. In the manner as mentioned above, a polymer (poly-L-lactic acid) as an intermediate product was continuously obtained in the reaction section 13.

The metering feeder 22 was operated to continuously supply D-lactide as the second monomer in the tank 21 into the biaxial stirring device of the contact section 29 at the feeding speed of 10 g/min. Moreover, the metering pump 28 was operated to continuously supply carbonic acid gas in the tank 27 into the biaxial stirring device of the contact section 29 so that an amount of the carbonic acid gas was 5 parts by mass relative to 100 parts by mass of the second monomer. As a result, lactide and the compressive fluid were continuously brought into contact with each other in the contact section 29 to thereby melt lactide. Note that, the feeding rate (feeding speed of the raw materials/feeding speed of the compressive fluid) in the contact section 29 was 20.

The polymer (poly-L-lactic acid) as an intermediate state in the melted state, which had been obtained through the polymerization performed in the reaction section 13, and D-lactide melted in the contact section 29 were continuously supplied into the two-axial kneader of the reaction section 33. As a result, a polymerization reaction of poly-L-lactic acid as the intermediate product and D-lactide as the second monomer was continuously performed in the reaction section 33.

Note that, in Example 1, the internal pressures of the contact section 9, reaction section 13, and reaction section 33 were set to 15 MPa by adjusting the opening degree of the pressure control valve 34. The temperature of the feeding path in the biaxial stirring devices in the contact section (9, 29) was 100° C. at the inlet, and 60° C. at the outlet. The inlet and outlet temperature of the feeding path in the reaction section 13 and reaction section 33 of the two-axial kneader were both 60° C. Moreover, the average retention time of the raw materials each in the contact section 9, reaction section 13, and reaction section 33 was controlled to 1,200 seconds by adjusting the pipeline system or length of the contact section 9, reaction section 13, and reaction section 33.

The pressure control valve 34 is provided at the edge of the reaction section 33, and a polymer (a stereo block copolymer of polylactic acid) as a final product was discharged from the pressure control valve 34. The values for physical properties of the obtained polylactic acid were determined in the aforementioned manners. The results are presented in Table 4.

### Examples 2-2 to 2-3

Polylactic acid was obtained in the same manner as in Example 2-1, provided that the amount of the initiator was changed. The values for physical properties of the obtained polylactic acid were determined in the aforementioned manners. The results are presented in Table 4.

### Examples 2-4 to 2-5

Polylactic acid was obtained in the same manner as in Example 2-1, provided that the monomer feeding rate between L-form and D-form was changed. The values for physical properties of the obtained polylactic acid were determined in the aforementioned manners. The results are presented in Table 4.

### Examples 2-6 to 2-7

Polylactic acid was obtained in the same manner as in Example 2-1, provided that the feeding ratio was changed. The values for physical properties of the obtained polylactic acid were determined in the aforementioned manners. The results are presented in Table 4.

### Example 2-8

Polylactic acid was obtained in the same manner as in Example 2-1, provided that tin di(2-ethylhexylate) was used as the catalyst, and the temperature of the feeding path was changed. The values for physical properties of the obtained polylactic acid were determined in the aforementioned manners. The results are presented in Table 4. Note that, “tin” in Table 4 represents tin di(2-ethylhexylate).

### Examples 2-9 to 2-10

Polylactic acid was obtained in the same manner as in Example 2-8, provided that the amount of the initiator was changed. The values for physical properties of the obtained polylactic acid were determined in the aforementioned manners. The results are presented in Table 5.

### Comparative Example 2-1

Polylactic acid was obtained in the same manner as in Example 2-8, provided that the amount of the initiator and the temperature of the feeding path were changed, and the polymerization was carried out without adding compressive fluid. The values for physical properties of the obtained polylactic acid were determined in the aforementioned manners. The results are presented in Table 5.

TABLE 4

| | | Ex. | Ex. | Ex. | Ex. | Ex. | Ex. | Ex. | Ex. |
|---|---|---|---|---|---|---|---|---|---|
| | | 2-1 | 2-2 | 2-3 | 2-4 | 2-5 | 2-6 | 2-7 | 2-8 |
| First monomer | | L-lactide | L-lactide | L-lactide | L-lactide | L-lactide | L-lactide | L-lactide | L-lactide |
| Second monomer | | D-lactide | D-lactide | D-lactide | D-lactide | D-lactide | D-lactide | D-lactide | D-lactide |
| Initiator amount | | 1.0 | 2.0 | 0.5 | 1.0 | 1.0 | 1.0 | 1.0 | 1.0 |
| (mol %) | | | | | | | | | |
| Catalyst | | DBU | DBU | DBU | DBU | DBU | DBU | DBU | tin |
| Feeding | Metering | 10 | 10 | 10 | 10 | 8 | 10 | 10 | 10 |
| rate | feeder 2 | | | | | | | | |
| (g/min) | Metering | 10 | 10 | 10 | 8 | 10 | 10 | 10 | 10 |
| | feeder 22 | | | | | | | | |
| Feeding | Contact | 20 | 20 | 20 | 20 | 20 | 10 | 5 | 20 |
| ratio | section 9 | | | | | | | | |
| | Contact | 20 | 20 | 20 | 20 | 20 | 10 | 5 | 20 |
| | section | | | | | | | | |
| | 29 | | | | | | | | |
| Set | Adjacent | 100 | 100 | 100 | 100 | 100 | 100 | 100 | 150 |
| temp. | inlet (° C.) | | | | | | | | |
| | Adjacent | 60 | 60 | 60 | 60 | 60 | 60 | 60 | 150 |
| | outlet | | | | | | | | |
| | (° C.) | | | | | | | | |

| | | | | | | | | |
|---|---|---|---|---|---|---|---|---|
| Internal pressure | 15 | 15 | 15 | 15 | 15 | 15 | 15 | 15 |
| of cylinder (MPa) | | | | | | | | |
| Mw | 31,000 | 16,000 | 58,000 | 14,000 | 15,000 | 14,000 | 15,000 | 31,000 |
| Molecular weight | 1.9 | 1.9 | 2.1 | 2.0 | 1.7 | 1.9 | 1.8 | 1.9 |
| distribution | | | | | | | | |
| (Mw/Mn) | | | | | | | | |
| Ring-opening | 0.8 | 0.8 | 0.5 | 1.0 | 0.5 | 0.6 | 0.5 | 0.8 |
| polymerizable | | | | | | | | |
| monomer residue | | | | | | | | |
| amount (mol %) | | | | | | | | |
| Stereo complex | 100 | 100 | 100 | 100 | 100 | 100 | 100 | 100 |
| crystallization degree (%) | | | | | | | | |
| Yellow Index value | 0.8 | 1.6 | 1.4 | 1.8 | 2.5 | 1.0 | 0.5 | 0.8 |

TABLE 5

| | | Ex. | Ex. | Comp. |
|---|---|---|---|---|
| | | 2-9 | 2-10 | Ex. 2-1 |
| First monomer | | L-lactide | L-lactide | L-lactide |
| Second monomer | | D-lactide | D-lactide | D-lactide |
| Initiator amount (mol %) | | 0.5 | 0.1 | 0.1 |
| Catalyst | | tin | tin | tin |
| Feeding | Metering | 10 | 10 | 10 |
| rate | feeder 2 | | | |
| (g/min) | Metering | 10 | 10 | 10 |
| | feeder 22 | | | |
| Feeding | Melt blending | 20 | 20 | — |
| ratio | device 9 | | | |
| | Belt blending | 20 | 20 | — |
| | device 29 | | | |
| Set | Adjacent inlet | 150 | 150 | 200 |
| temp. | (° C.) | | | |
| | Adjacent | 150 | 150 | 200 |
| | outlet (° C.) | | | |

| | | | |
|---|---|---|---|
| Internal pressure of | 15 | 15 | 15 |
| cylinder (MPa) | | | |
| Mw | 58,000 | 240,000 | 180,000 |
| Molecular weight | 1.9 | 2.1 | 2.1 |
| distribution (Mw/Mn) | | | |
| Ring-opening | 0.8 | 0.5 | 4.6 |
| polymerizable monomer | | | |
| residue amount (mol %) | | | |
| Stereo complex | 100 | 100 | 85 |
| crystallization degree (%) | | | |
| Yellow Index value | 1.6 | 1.4 | 7.8 |

The embodiments of the present invention are, for example, as follows:

<1> A polymer composition, containing:

stereo complex crystals; and

substantially no organic solvent,

wherein an amount of ring-opening polymerizable monomer residues is 2 mol % or less.

<2> The polymer composition according to <1>, wherein a stereo complex crystallization degree of the polymer composition, which is represented by the following formula, is 90% or greater,

S=[ΔHmsc/(ΔHmh+ΔHmsc)]×100

where S is a stereo complex crystallization degree (%), ΔHmsc is heat of melting (J/g) of the stereo complex crystals, and ΔHmh is heat of melting (J/g) of homocrystals that do not contribute to formations of the stereo complex crystals.

<3> The polymer composition according to any of <1> or <2>, wherein the polymer composition has a yellow index value of 5 or less.
<4> The polymer composition according to any one of <1> to <3>, wherein the polymer composition has a weight average molecular weight of 12,000 or greater.
<5> The polymer composition according to any one of <1> to <4>, wherein the polymer composition contains substantially no metal atom.
<6> The polymer composition according to any one of <1> to <5>, wherein the polymer composition contains a first polymer obtained through ring-opening polymerization of a first ring-opening polymerizable monomer, and a second polymer obtained through ring-opening polymerization of a second ring-opening polymerizable monomer which is an optical isomer of the first ring-opening polymerizable monomer,

wherein a total amount of residues of the first ring-opening polymerizable monomer and residues of the second ring-opening polymerizable monomer is 2 mol % or less.

<7> The polymer composition according to <6>, wherein the first polymer contains a carbonyl bond.
<8> The polymer composition according to <7>, wherein the first polymer is polyester.
<9> The polymer composition according to any one of <6> to <8>, wherein the first polymer is obtained through ring-opening polymerization of the first ring-opening polymerizable monomer with a compressive fluid and a catalyst, and the second polymer is obtained through ring-opening polymerization of the second ring-opening polymerizable monomer with a compressive fluid and a catalyst.
<10> The polymer composition according to <9>, wherein the first polymer and the second polymer are mixed using the compressive fluid.
<11> The polymer composition according to any of <9> or <10>, wherein the catalyst is an organic catalyst containing no metal atom.
<12> The polymer composition according to <11>, wherein the organic catalyst is 1,4-diazabicyclo-[2.2.2]octane, 1,8-diazabicyclo[5.4.0]undec-7-ene, 1,5,7-triazabicyclo[4.4.0]dec-5-ene, diphenyl guanidine, N,N-dimethyl-4-aminopyridine, 4-pyrrolidinopyridine, or 1,3-di-tert-butylimidazol-2-ylidene.

### REFERENCE SIGNS LIST

1 tank
2 metering feeder
3 tank
4 metering feeder
5 tank
6 metering pump
7 tank
8 metering pump
9 contact section
10 feeding pump
11 tank
12 metering pump
13 reaction section
14 metering pump
21 tank
22 metering feeder
27 tank
28 metering pump
29 contact section
33 reaction section
100 polymerization reaction device
100a supply unit
100b polymerization reaction device
300 complex production device
PP polymer composition

1. A polymer composition, comprising:
stereo complex crystals; and
substantially no organic solvent,
wherein an amount of ring-opening polymerizable monomer residues is 2 mol % or less.

2. The polymer composition according to claim 1,
wherein a stereo complex crystallization degree of the polymer composition is 90% or greater, and
the stereo complex crystallization degree of the polymer composition is represented by the following formula:
S=[ΔHmsc/(ΔHmh+ΔHmsc)]×100,
where S is a stereo complex crystallization degree (%),
ΔHmsc is heat of melting (J/g) of the stereo complex crystals, and
ΔHmh is heat of melting (J/g) of homocrystals that do not contribute to formations of the stereo complex crystals.

3. The polymer composition according to claim 1,
wherein the polymer composition has a yellow index value of 5 or less.

4. The polymer composition according to claim 1,
wherein the polymer composition has a weight average molecular weight of 12,000 or greater.

5. The polymer composition according to claim 1,
wherein the polymer composition comprises substantially no metal atom.

6. The polymer composition according to claim 1,
comprising:
a first polymer obtained through ring-opening polymerization of a first ring-opening polymerizable monomer, and
a second polymer obtained through ring-opening polymerization of a second ring-opening polymerizable monomer which is an optical isomer of the first ring-opening polymerizable monomer,
wherein a total amount of residues of the first ring-opening polymerizable monomer and residues of the second ring-opening polymerizable monomer is 2 mol % or less.

7. The polymer composition according to claim 6,
wherein the first polymer comprises a carbonyl bond.

8. The polymer composition according to claim 7,
wherein the first polymer is polyester.

9. The polymer composition according to claim 6,
wherein the first polymer is obtained through ring-opening polymerization of the first ring-opening polymerizable monomer with compressive fluid in the presence of a catalyst, and
the second polymer is obtained through ring-opening polymerization of the second ring-opening polymerizable monomer with compressive fluid in the presence of a catalyst.

10. The polymer composition according to claim 9,
wherein the first polymer and the second polymer are mixed with the compressive fluid.

11. The polymer composition according to claim 9,
wherein the catalyst is an organic catalyst comprising no metal atom.

12. The polymer composition according to claim 11,
wherein the organic catalyst is 1,4-diazabicyclo-[2.2.2]octane, 1,8-diazabicyclo[5.4.0]undec-7-ene, 1,5,7-triazabicyclo[4.4.0]dec-5-ene, diphenyl guanidine, N,N-dimethyl-4-aminopyridine, 4-pyrrolidinopyridine, or 1,3-di-tert-butylimidazol-2-ylidene.
